(19) United States
(12) Patent Application Publication
(10) Pub. No.: US 2008/0097897 A1
(43) Pub. Date: Apr. 24, 2008

(54) System and Method of Express Creation and Initialization of Merchant Accounts

(75) Inventors: Brian R. Sadowski, Gilbert, AZ (US); Mark K. Reha, Litchfield Park, AZ (US); Deborah M. Grant, Scottsdale, AZ (US); David L. Dilli, Phoenix, AZ (US); Robert W. Blair, Atlanta, GA (US)

Correspondence Address: QUARLES & BRADY LLP, RENAISSANCE ONE, TWO NORTH CENTRAL AVENUE, PHOENIX, AZ, 85004-2391, US

(73) Assignee: TSYS Acquiring Solutions, L.L.C., Tempe, AZ (US)

(21) Appl. No.: 11/551,624

(22) Filed: Oct. 20, 2006

(51) Int. Cl. G06Q 40/00

(52) U.S. Cl. 705/38

(57) ABSTRACT

A credit card processing system uses an express processing module to create and initialize merchant accounts. The credit card processing system includes a merchant, bank, and credit card association which are connected by electronic communication links. The express processing module uses a plurality of data entry screens to compile and format merchant data for transmission to the bank which in turn opens the merchant accounts upon completion and approval of all data requirements. The express processing module further manages workflow of the applications for each of the plurality of merchants by tracking data entry progress and assigning resources to complete the applications and meet requirements for creation and initialization of the merchant accounts. The express processing module uses a plurality of web services handlers to interface with external systems to handle requests for information.

### CROSS-REFERENCE TO RELATED PATENT APPLICATIONS

The present patent application is related to co-pending U.S. patent application Ser. No. ______, Attorney Docket No. 127121.00004, entitled “System and Method of Managing Workflow during Express Creation and Initialization of Merchant Accounts,” and filed concurrently herewith. The present patent application is further related to co-pending U.S. patent application Ser. No. ______, Attorney Docket No. 127121.00005, entitled “System and Method of Interfacing Web Services to Express Creation and Initialization of Merchant Accounts,” and filed concurrently herewith.

### FIELD OF THE INVENTION

The present invention relates in general to credit card processing systems and, more particularly, to a system and method of express creation and initialization of merchant accounts by collecting merchant data through an integrated data collection system.

### BACKGROUND OF THE INVENTION

An integral part of many financial transactions involves the purchase of goods and services by credit card or other electronic transfer of funds. Consumers use credit cards to purchase goods and services from merchants and service providers. Businesses and government agencies use electronic fund transfers to acquire goods and services and issue credit cards to employees as necessary to conduct business. Credit cards are a convenient, safe, effective, and integral part of the economy.

There are typically three financial institutions involved in credit card transactions: card association, issuing bank, and acquiring bank. Well-known card associations operate under the names of Visa® and MasterCard®. The issuing bank issues a credit card to a cardholder. The credit card will include a credit line that will impose certain limits on the cardholder's ability to make purchases. The cardholder agrees to pay the amount due on the credit card statement, or a minimum portion thereof with interest on the balance, to the issuing bank. The merchant has an account or relationship with the acquiring bank to initiate credit card transactions and ultimately receive payment for the transaction. The card association operates between the acquiring bank and issuing bank to coordinate and simplify the large number of transactions occurring on a daily basis.

A credit card transaction usually starts at the point of sale where the cardholder has selected merchandise or services which he or she wishes to purchase. The merchant or service provider enters the credit card number by swiping the card through a terminal to read information stored on the magnetic strip or enters the credit card number directly into the terminal keypad. The terminal is connected to a communication network which electronically links the merchant to the acquiring bank or processing center. The acquiring bank is electronically linked to the card association and the card association is electronically linked to the issuing bank.

In most credit card transactions, the cardholder is interacting with the merchant at the point of sale. In a first part of the process, a purchase authorization request is forwarded via an electronic communication network through the acquiring bank and card association to the issuing bank. The purchase authorization includes the merchant identification, amount of the purchase, and cardholder information. The cardholder information may include the account number, PIN number, fraud protection data, etc. The purchase authorization checks with the issuing bank to see that the cardholder account is in good-standing with the bank, that the purchase is within the cardholder account's approved credit limit, and that there are no other irregularities. The issuing bank approves the transaction for the requested amount and routes the approval back through the card association and acquiring bank to the merchant. Even though no money changes hands, the cardholder and merchant complete their interaction. The cardholder leaves the store with the merchandise in hand and the merchant receives assurance that the money will be paid.

In the second part of the process, an aggregation of the individual purchase authorizations is processed through the credit card system to fund authorized transactions in a process known as clearing and settlement. During clearing and settlement, monies are transferred between accounts to complete specific pre-approved transactions. An issuing bank may need to pay monies to a large number of acquiring banks and an acquiring bank may expect to receive monies from a large number of issuing banks. By operating through the card association, the issuing bank makes one wire transfer to the card association to make payments to specific acquiring banks. Likewise, the acquiring bank receives one wire transfer from the card association to settle transactions for specific issuing banks. The card association receives funds and allocates funds to its individual members in order to clear and settle pending and approved credit card transactions.

Before a merchant can utilize the credit card processing system as described above, the merchant must establish an account with the acquiring bank and possibly other financial institutions within the credit card processing system. The ability to use the credit card processing system is important to the merchant as a large percentage of purchases are made via credit cards. Merchants understand that customers demand the option of paying for goods and services with credit cards. In order to gain approval to use the credit card processing system, the merchant must apply for an account. The acquiring bank checks the application for completeness and content to decide whether the merchant is credit-worthy to be given an account through which to process credit card transactions. During the application process, the acquiring bank creates and initializes the credit card account which, when finally approved, enables the merchant's terminal to process credit card transactions.

In the application process, the acquiring bank collects a substantial amount of business and financial data from the merchant. If the merchant data is incomplete or inaccurate, the application process can be delayed. Depending on the acquiring bank's system, if a problem is encountered, part or all of the application process may have to be repeated and the data re-entered. Sometimes the account approval is delayed because adequate resources cannot be delegated to process the application as efficiently as the merchant might hope. The sign-up process is generally disjointed, time-consuming, and prone to errors, particularly when required information must be entered manually multiple times, through multiple systems, each with their own forms, requirements, and idiosyncrasies.

A need exists to improve the procedures and process of creating and initializing merchant accounts.

### SUMMARY OF THE INVENTION

In one embodiment, the present invention is a computer-implemented method of express creation and initialization of merchant accounts comprising the steps of providing a credit card processing system including a merchant, bank, and credit card association connected by electronic communication links, and providing an express processing module with electronic communication links to the merchant and bank, wherein the express processing module provides for creation and initialization of merchant accounts with the bank by entering merchant data through a plurality of data entry screens within the express processing module. The merchant data is compiled and formatted for transmission to the bank which in turn opens the merchant accounts upon completion and approval of all data requirements.

In another embodiment, the present invention is a computer-implemented method of express creation and initialization of merchant accounts comprising the steps of providing a credit card processing system including a merchant and bank connected by an electronic communication link, and providing an express processing module with electronic communication links to the merchant and bank, wherein the express processing module provides for creation and initialization of merchant accounts with the bank by entering merchant data through a plurality of data entry screens within the express processing module. The merchant data is compiled and formatted for transmission to the bank which in turn opens the merchant account upon completion and approval of all data requirements.

In another embodiment, the present invention is a computer-implemented method of express creation and initialization of accounts comprising the steps of providing a processing system having a plurality of components connected by electronic communication links, and providing an express processing module with electronic communication links to the plurality of components, wherein the express processing module provides for creation and initialization of accounts with a first component for the benefit of a second component by entering data through a plurality of data entry screens within the express processing module. The data is compiled and formatted for transmission to the first component which in turn opens the account for the second component upon completion and approval of all data requirements.

In another embodiment, the present invention is a computer program product usable with a programmable computer processor having a computer readable program code embodied therein comprising a computer readable program code which interacts with a credit card processing system including a merchant and bank connected by an electronic communication link, and establishes an express processing module with electronic communication links to the merchant and bank, wherein the express processing module provides for creation and initialization of merchant accounts with the bank by entering merchant data through a plurality of data entry screens within the express processing module. The merchant data is compiled and formatted for transmission to the bank which in turn opens the merchant account upon completion and approval of all data requirements.

In another embodiment, the present invention is a computer system for express creation and initialization of merchant accounts comprising means for providing a credit card processing system, including a merchant and bank connected by an electronic communication link, and means for providing an express processing module with electronic communication links to the merchant and bank, wherein the express processing module provides for creation and initialization of merchant accounts with the bank by entering merchant data through a plurality of data entry screens within the express processing module. The merchant data is compiled and formatted for transmission to the bank which in turn opens the merchant account upon completion and approval of all data requirements.

### BRIEF DESCRIPTION OF THE DRAWINGS

FIG. 1 is a block diagram of an electronic credit card processing system with an integrated express processing module;

FIG. 2 is a flowchart of the operation of the express processing module;

FIG. 3 is a block diagram of the express processing module interacting with the credit card processing system;

FIG. 4 is a block diagram illustrating components of the express processing module;

FIG. 5 is a block diagram of the presentation tier, business logic tier, and data persistence tier within certain components of the express processing module;

FIG. 6 is a data entry screen for the express homepage;

FIG. 7 is a data entry screen for adding merchants to the workflow;

FIG. 8 is a data entry screen for merchant parameters;

FIG. 9 is a data entry screen for merchant name and address;

FIG. 10 is a data entry screen for miscellaneous merchant information;

FIG. 11 is a data entry screen for merchant account information;

FIG. 12 is a data entry screen for merchant interchange information;

FIG. 13 is a data entry screen for merchant automated clearing house information;

FIG. 14 is a data entry screen for merchant product information;

FIG. 15 is a data entry screen for merchant card plans;

FIG. 16 is a data entry screen for merchant charge records;

FIG. 17 is a data entry screen for merchant point to BETs;

FIG. 18 is a data entry screen for merchant credit information;

FIG. 19 is a data entry screen for merchant leasing information;

FIG. 20 is a data entry screen for the express report generator;

FIG. 21 is a data entry screen for merchant match inquiry;

FIG. 22 is a data entry screen for advanced merchant searches;

FIG. 23 is a data entry screen for third party status;

FIG. 24 is a data entry screen for merchant account range;

FIG. 25 is a data entry screen for global audit searches;

FIG. 26 is a data entry screen for note summary;

FIG. 27 is a data entry screen for merchant terminal requests;

FIG. 28 is a data entry screen for merchant terminal details;

FIG. 29 is a data entry screen for merchant terminal retirement summary;

FIG. 30 is a data entry screen for BIN setup information;

FIG. 31 is a data entry screen for work in process information;

FIG. 32 is a data entry screen for merchant summary information;

FIG. 33 is a block diagram illustrating interface of web services to express processing module;

FIG. 34 is a chart showing values for each terminal field;

FIG. 35 is a flowchart of the steps involved in the express creation and initialization of the merchant accounts; and

FIG. 36 is a computer network for executing the method of express creation and initialization of merchant accounts.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

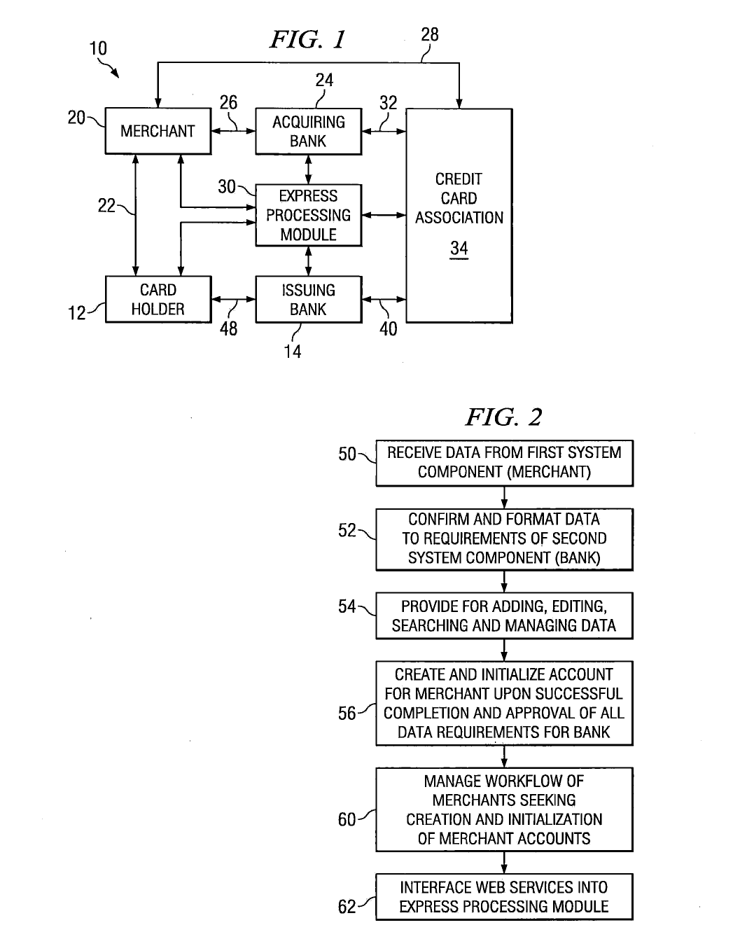

An electronic credit card processing system 10 is shown in FIG. 1 for handling credit card transactions between a cardholder and a merchant and the various financial institutions operating between these parties. Credit card processing system 10 is used in many financial transactions involving purchase of goods and services by credit card or other electronic transfer of funds. Consumers use credit cards to purchase goods and services from merchants and service providers. Businesses and government agencies use electronic fund transfers to acquire goods and services and issue credit cards to employees as necessary to conduct business.

Credit card processing system 10 is a computer-based communication and transaction processing network with electronic links between parts of the system. Each of the communication links described herein can be direct hard-wired lines, leased high-bandwidth lines, telephone lines, fiber optic cable, wireless, satellite, or the like.

Credit card processing system 10 includes a relationship between cardholder 12 and issuing bank 14. Cardholder 12 can be an individual, corporation, or other legal entity that establishes a line of credit with issuing bank 14 based on their credit rating and credit risk. Issuing bank 14 issues a credit card or other credit instrument to cardholder 12. Cardholder 12 has the ability to purchase goods and services and otherwise pay debts using the credit card, within the limits imposed by issuing bank 14. Issuing bank 14 assumes responsibility to make good on any charge or debt properly incurred by cardholder 12 within established credit limits. Cardholder 12 agrees to pay the amount due on the credit card statement, or a minimum portion thereof with interest on the balance, to issuing bank 14.

With credit card in hand, cardholder 12 can conduct business and make purchases with most business entities. For example, cardholder 12 can enter the place of business of merchant 20 and purchase goods or services with the credit card. Alternately, cardholder 12 may make purchases over the telephone or on-line via merchant 20's internet website, FIG. 1 illustrates the interactive commercial relationship between cardholder 12 and merchant 20 by link 22.

Cardholder 12 makes his or her purchase selections and provides the credit card to merchant 20. Merchant 20 swipes the credit card through a terminal to read the information stored on the magnetic strip, or enters the credit card number into the terminal keypad, or calls-in the credit card number by telephone into a processing center. The merchant's terminal is connected to acquiring bank 24 by electronic communication link 26.

Merchant 20 has an account or relationship with acquiring bank 24, which must be created and initialized before use. A transaction between cardholder 12 and merchant 20 involves the transmission of data from merchant 20 to acquiring bank 24 by way of communication link 26. The transaction data includes (1) identification and other information related to cardholder 12 as read from the magnetic strip on the back of the credit card, (2) identification and other information related to merchant 20, and (3) the amount of the purchase or transaction. The cardholder information may include name, address, primary account number, PIN number, fraud protection data, etc. The transmission of data is encrypted to prevent fraud and unauthorized access to sensitive and confidential information related to cardholder 12 and merchant 20.

Acquiring bank 24 processes the transaction by making a record in its computer database, and possibly re-formatting the data or adding additional information according to its own procedures. Acquiring bank 24 may use a third-party processor for some or all of its transaction processing functions. In the present example, the transaction is routed to credit card association 34 over communication link 32. In other applications, merchant 20 may have a direct relationship with credit card association 34 as shown by communication link 28.

Card association 34 includes well-known institutions identified by names such as Visa® and MasterCard®. Card association 34 operates between acquiring bank 24 and issuing bank 14 to coordinate and simplify the large number of credit card transactions occurring on a daily basis. Card association 34 routes the transaction to issuing bank 14 over communication link 40.

Issuing bank 14 has primary authority and assumes the principal risk of approving and settling the transaction. Issuing bank 14 processes the transaction and routes the response back through communication link 40 to card association 34. Card association 34 routes the response from issuing bank 14 back through communication link 36 to acquiring bank 24 by communication link 32. Merchant 20 receives the issuing bank's response to the transaction from acquiring bank 24 by communication link 26.

As mentioned, there are variations to the above process. By way of example, in certain situations and with certain arrangements, credit card association 34 may receive a transaction generated by merchant 20 and respond back to acquiring bank 24 by communication link 32 or directly back to merchant 20 by communication link 28.

As an illustration of transaction processing system 10, assume credit card transaction A is defined as cardholder 12 making a purchase from merchant 20. In credit card transaction A, cardholder 12 enters the place of business of merchant 20 with credit card in hand to purchase goods or services. Cardholder 12 makes his or her purchase selections and provides the credit card to merchant 20. Merchant 20 swipes the credit card through a terminal to read the information stored on the magnetic strip. At this point in the process, where cardholder 12 is directly interacting with merchant 20, the transaction is a purchase authorization request. The purchase authorization checks to see that the cardholder is in good-standing with the bank, that the purchase is within his or her approved credit limit, and that there are no other irregularities. No monies change hands or accounts between cardholder 12 and merchant 20 at the point of sale. Instead, merchant 20 is simply requesting authorization for the amount of the purchase. Often times, merchant 20 does not know, understand, or even care who or what is approving the authorization. Merchant 20 just wants the purchase authorization to come back fast and be approved. The obligation and reputation of the financial entity identified on the credit card or other entity who assumes the risk of the transaction gives merchant 20 confidence that payment is in fact forthcoming.

The purchase authorization request is routed across communication link 26 to acquiring bank 24. Acquiring bank 24 processes the request by making a record in its computer database, and possibly re-formatting the authorization request or adding additional information according to its own procedures. The purchase authorization request is routed to credit card association 34 over communication link 32. Card association 34 forwards the purchase authorization request to issuing bank 14 by communication link 40. Issuing bank 14 then approves or denies the purchase authorization for the requested amount and routes the approval or denial back through card association 34 and acquiring bank 24 to merchant 20 in the reverse order previously described. If the purchase authorization is approved, cardholder 12 and merchant 20 complete their transaction. Cardholder 12 leaves the store with the merchandise and a record of the transaction and merchant 20 receives assurance that the money will be paid. If the purchase authorization request is denied, cardholder 12 can offer another form of payment or forego the purchase.

Clearing and settlement is another type of transaction that can be processed through transaction processing system 10. The transfer and exchange of money, sometimes in different currencies, can be a time-consuming, expensive, and error-prone process. The aggregation of purchases and payment of net proceeds to the parties during clearing and settlement is a more efficient and cost-effective alternative to exchanging money for each transaction. Clearing and settlement may occur at the end of the day or at regular intervals during the day, or once every few days depending on the volume of transactions and needs of the parties.

In clearing and settlement, monies actually exchange hands by electronic transfer between accounts to complete previously approved but as of yet unsettled transactions. A number of purchase authorization requests like transaction A are approved throughout the day or other periods of time as determined by merchant 20 or acquiring bank 24. During clearing and settlement, an aggregation of the individual purchase requests is processed through credit card association 34 to fund previously approved transactions.

Depending on the system, one of the parties, e.g., merchant 20 or acquiring bank 24, initiates a clearing and settlement transaction in many cases at the end of the business day. The clearing and settlement transaction includes and represents specific credit card transactions, including transaction A, which have been approved and accrued since the last clearing and settlement transaction. The clearing and settlement transaction is routed from merchant 20 to acquiring bank 24 by communication link 26. If merchant 20 is a large institution, or if merchant 20 has special arrangements with acquiring bank 24, then acquiring bank 24 may forward the single clearing and settlement transaction for merchant 20 to credit card association 34. Alternatively, acquiring bank 24 may accumulate a number of clearing and settlement transactions from smaller merchants before forwarding an aggregate clearing and settlement transaction to credit card association 34.

Card association 34 accumulates clearing and settlement transactions from a number of sources, e.g., other acquiring banks or other transaction processing centers, which are intended for each issuing bank. The clearing and settlement transaction from merchant 20 intended to clear and settle transaction A, along with other transactions from merchant 20 and from other merchants and other acquiring banks, each intended for issuing bank 14, are accumulated, sorted, processed, and routed to issuing bank 14 by card association 34.

Issuing bank 14 reviews the aggregate clearing and settlement transaction from card association 34 and, if all is in order with the pre-approved authorization requests, executes a wire transfer of funds, or authorizes deduction from accounts established within card association 34, for payment of the specific approved transactions made during the clearing and settlement period with merchants that have transacted with cardholders using credit cards issued by issuing bank 14. In other words, the funds paid by issuing bank 14 will be sufficient to cover payments which card association 34 must make to specific acquiring banks to cover monies due to merchants for authorized purchases made by cardholders using credit cards issued by issuing bank 14. Issuing bank 14 sends credit card statements on a periodic basis, e.g., monthly, to its cardholders for the purchases made during the period as shown by link 48. Issuing bank 14 assumes the risk whether the cardholder will pay the bill. Issuing bank 14 earns its revenue from fees and interest charges received from cardholders on any unpaid balance due on the statements.

The issuing banks belonging to card association 34 make payment thereto to clear and settle specific pre-approved outstanding transactions. Card association 34 then makes payments to specific acquiring banks with the funds received from the issuing banks. One of those payments from card association 34 will go to acquiring bank 24, which then credits the account of merchant 20 for transaction A. That is, a portion of the payment made by card association 34 to acquiring bank 24 will be used to pay merchant 20 for transaction A.

A principal function of card association 34 is to act as a funding clearing house for clearing and settlement. Issuing bank 14 may need to pay monies to a large number of acquiring banks, and acquiring bank 24 may expect to receive monies from a large number of issuing banks. By operating through card association 34, issuing bank 14 makes one wire transfer or authorization to debit its account to card association 34 who in turn makes payments to specific acquiring banks. Likewise, acquiring bank 24 receives one wire transfer from card association 34 to settlement transactions for specific issuing banks.

Express processing module 30 shown in FIG. 1 is an integral part of credit card processing system 10. Express processing module 30 has communication links with each of the major components of credit card processing system 10, i.e., card holder 12, merchant 20, issuing bank 14, acquiring bank 24, and credit card association 34. Express processing system 30 is able to electronically send and receive data with each of these system components by the communication links. Module 30 performs routine and repetitive functions for each of the modules for efficiency and to minimize errors. In one embodiment, express processing module 30 provides a setup function for creation and initialization of merchant accounts. Express processing module 30 contains a number of data entry screens with data fields to collect the necessary information from merchant 20 to be able to utilize all of the functions described above for credit card processing system 10. Typically, the express processing module is handled by third party service provider working between the merchant and the bank.

As described above, express processing module 30 allows merchant 20 to establish accounts with acquiring bank 24 and/or credit card association 34. That is, a merchant terminal must be setup to identify itself to acquiring bank 24 or credit card association 34 and to function with each type of credit card. A merchant terminal is the hardware device that is typically located on the merchant's counter or cash register that reads the magnetic strips on the back of credit cards and sends the purchase transaction to acquiring bank 24 or credit card association 34. Similarly, card holder 12 can create and initialize accounts with issuing bank 14 and card association 34. Express processing module 30 receives one set of data entry and then formats the information to the requirements of each of the other system components.

FIG. 2 shows the basic flowchart of express processing system 30. Block 50 receives data from a first system component of credit card processing system 10. In the present example, merchant 20 provides business data for initializing various accounts within the system. Block 52 confirms and formats the data for a second system component, e.g., acquiring bank 24. Block 54 provides for adding, editing, searching, and managing the data. Block 56 creates and initializes the account for the first system component. The account is open upon successful completion and approval of all data requirements. Block 60 manages workflow of various merchants applying for merchant accounts. Block 62 interfaces various web services into the express processing module.

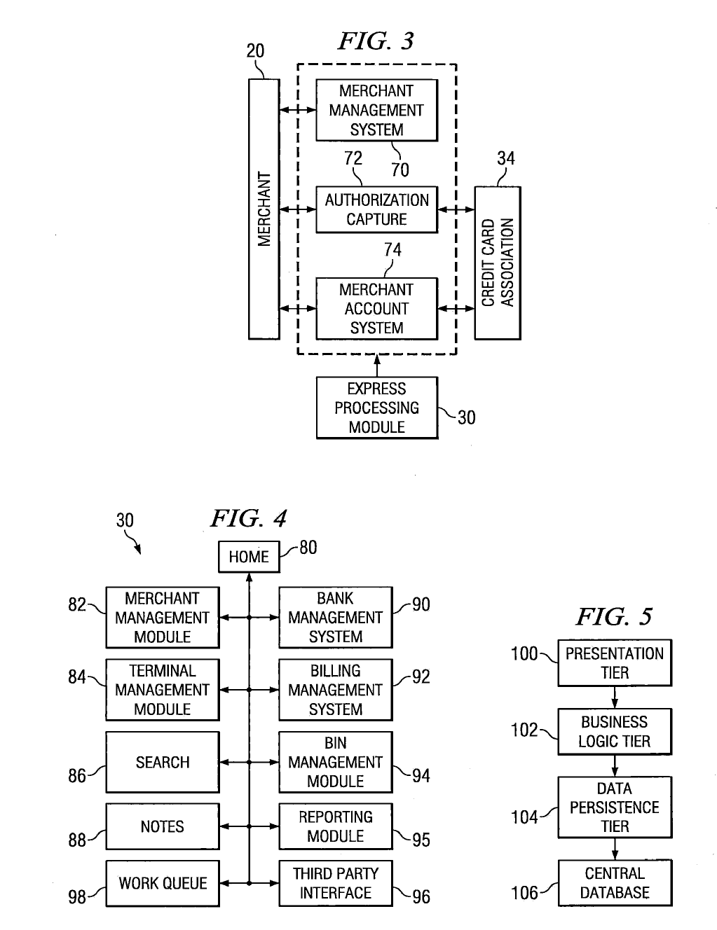

Further detail of a portion of credit card processing system 10 is shown in FIG. 3. Acquiring bank 24 interacts with merchant management module (MMS) 70 to manage the credit card transaction. To initialize the system, merchant 20 identifying information, i.e., merchant name, address, terminal number, etc. is provided. MMS 70 downloads the software for the merchant terminal to communicate with acquiring bank 24 and credit card association 34 and executes purchase transactions. Once the merchant terminal is initialized, authorization capture 72 handles authorization for each purchase transaction. When card holder 12 swipes his/her credit card to make a purchase of the merchant's goods or services, the card holder 12 identification, i.e., credit card number, name, and card verification value (CVV), is sent to credit card association 34 and issuing bank 14 for purchase authorization. The authorization comes back with an approval or denial. The purchase transaction is complete and card holder 12 receives their goods or services. When it comes time for clearing and settlement, merchant's terminal interacts with merchant account system 74 to send a composite file of all purchase transactions to credit card association 34 for payment. Since merchant 20 has been initialized and is part of the system, credit card association 34 transfers funds to acquiring bank 24 on behalf of the merchant 20 to reconcile all outstanding purchase transactions. Merchant 20 receives a statement of all transaction activity.

In order to utilize the aforedescribed credit card processing system, merchant 20 must first establish an account with acquiring bank 24. The merchant must make application to open such an account and in doing so provide all relevant business data to the bank. The application process for a merchant account involves collecting the necessary data and initializing the necessary services to fully utilize all the features of credit card processing system 10 as described above. The data collection, confirmation, and approval process is referred to as creation and initialization of the merchant's account. The creation and initialization process of express processing module 30 makes it convenient for a merchant account to be opened as the data is collected in one central system, stored, managed, and formatted to the requirements of each component of the credit card processing system as needed.

As illustrated in FIG. 3, express processing module 30 simplifies the creation and initialization of merchant accounts in order to utilize the credit card processing system 10. Express processing module 30 receives data entry from one component, e.g., acquiring bank 24 on behalf of merchant 20, one time for each unit of information, possibly over a series of data entry sessions. For example, the merchant name and address is entered only one time and then that information is used in other data entry screens as needed. Each unit of information can be re-used once it is entered; there is no need to enter the same information again. Each unit of information is checked for accuracy and completeness. Once the merchant data is complete, express processing module 30 forwards the application to the bank for approval and then creates accounts and initializes other system components in order to fully utilize the system. In the case of merchant 20, express processing module 30 receives data entry on behalf of merchant 20 and then uses that data to initialize the merchant terminal and create accounts for authorization capture 72 and MAS 74, including authorizations, clearing and settlement, and reporting functions.

The function of express processing module 30 will be described in terms of setting up a merchant account with the acquiring bank. It is understood that the following discussion can apply to coordinating data creation, initialization, and exchange between the other system components.

FIG. 4 illustrates a functional block diagram of express processing module 30. Home page 80 provides a top level view of the services within module 30. Merchant management module 82 interfaces with MAS 74 and allows the user to add, edit, and maintain merchant data, as will be explained in further detail below. Terminal management module 84 interfaces with MMS 70 and allows the user to add, edit, and maintain merchant terminal data. In another embodiment, the functionality of MMS 70 and MAS 74 can be integrated into merchant management module 82 and terminal management module 84, respectively. Search module 86 allows the user to search the system for given criteria, e.g., to find previously entered merchant data. Notes module 88 allows the user to enter and query text information about work assignments.

Home page 80 also gives access to bank management system 90, which allows the user to add, edit, and manage accounts with associated banks, e.g., acquiring bank 24 and issuing bank 14. Billing management system 92 allows the user to set various options for billing merchant 20 for credit card processing services rendered. Bank identification number (BIN) management module 94 allows the user to add, edit, and manage clearing and settlement accounts. Reporting module 95 allows the user to requests reports and execute pre-established reports related to the credit card processing functions.

Third party interface 96 allows the user to interact with various external communication links and services, e.g., other components of credit card processing system 10, MMS 70, MAS 74, Transaction Network Services (TNS), and American Express®.

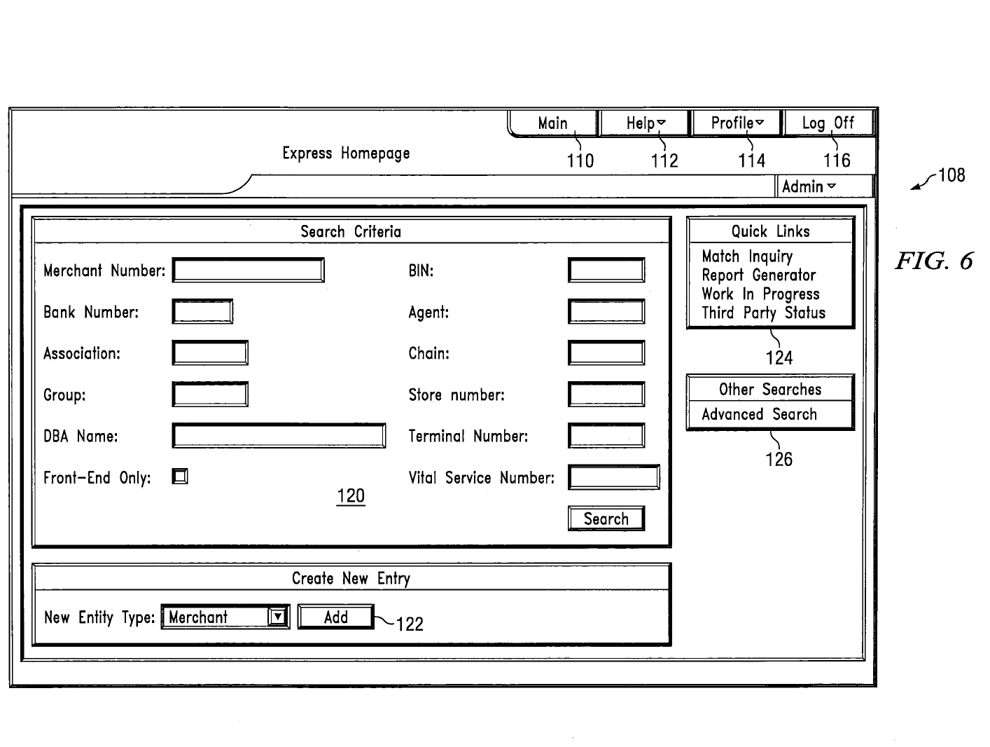

Each functional block 82-98 of express processing module 30 may contain one or more of the following components: a presentation tier 100, business logic tier 102, and data persistence tier 104 which communicates with central database 106, as shown in FIG. 5. Presentation tier 100 handles the graphical user interface (GUI) and electronic interface into other modules and external systems. The data entry screens of FIGS. 6-32 are contained with presentation tier 100. The GUI can be customized to be client-specific in terms of format, data entry, and error correction. Business logic tier 102 allows the user to define rules by which the module will operate. Data persistence tier 104 handles the interface with central database 106, where all merchant data is stored. Data persistence tier ensures that the inbound and outbound data to central database 106 is handled consistently for all modules.

FIGS. 6-32 illustrate the GUI to express processing module 30. Each data entry screen can be used locally or downloaded remotely from one or more websites on the Internet. In explaining the data entry screen, assume the user wants to setup or make changes to a merchant account with the acquiring bank. The merchant can be a retailer that offers goods or services to the public. The account with the bank is necessary for the merchant to setup the terminal to process credit card transactions. In order to have an account, merchant 20 must make application therefor. In the application process, a significant amount of merchant data must be provided to the acquiring bank. Express processing module 30 simplifies the entry of the merchant data so the steps of creating and initializing the account become more efficient. In general, the user enters the merchant data into the data entry screens of express processing module 30. Express processing module 30 performs formatting and error checking on the merchant data. The data entry screens of the express processing module are customized to perform data entry formatting and error checking according to requirements of the bank. The bank may want certain data entered before other data. For example, the bank may want the merchant's credit history portion of the application complete before entering terminal information. Each field of each data screen is thus configurable to accommodate the requirement of each bank. Certain data fields may default to a given value and certain data fields may be disabled, again depending on the requirements and preferences of the bank, see discussion of FIG. 34. The error checking process compares the data entered into each field against acceptable values. The data can also be cross-compared between different fields and between different data entry screens for consistency. When an error occurs, an appropriate error message is displayed for the user. Once the merchant information is entered, then the express processing module 30 will create and initialize all necessary accounts for merchant 20 to fully utilize system 10.

FIG. 6 illustrates the express homepage 108. As will be similar for other data entry screens, the express homepage has main button 110, help button 112, profile button 114, and logoff button 116. The user can enter pre-existing merchant data in section 120, e.g., merchant number, bank number, association, group, DBA name, front-end only box, BIN, agent, chain, store number, terminal number, and vital service number. Alternatively, the user can add new merchant with ADD button 122. Box 124 provides quick links to other express functions. Box 126 provides access to more advanced searches.

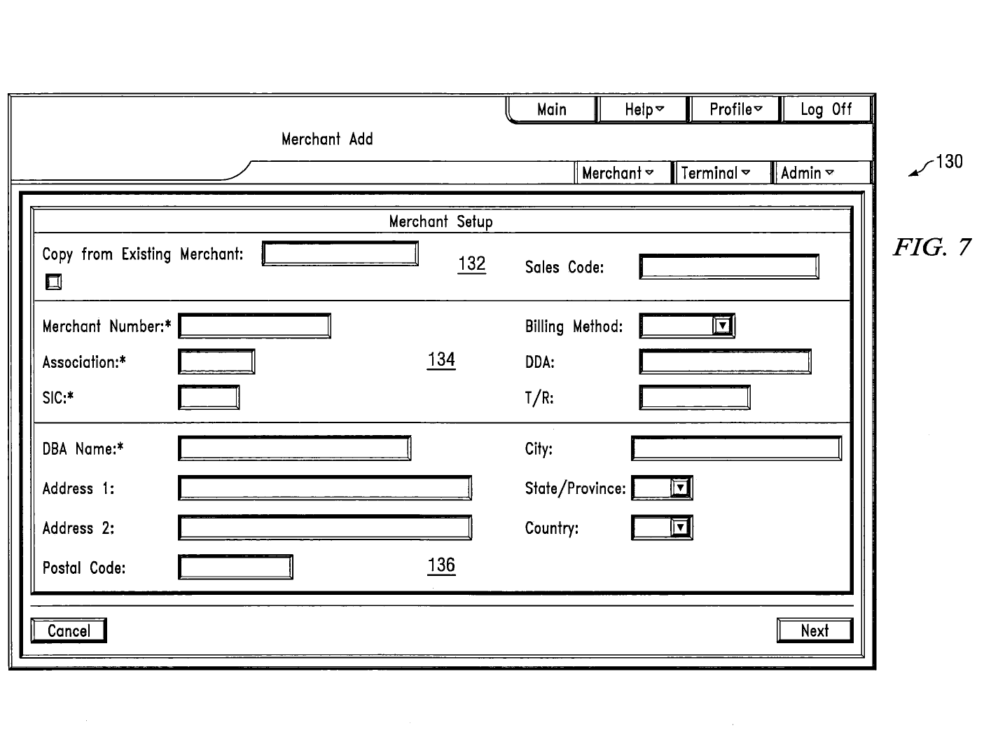

Selecting ADD button 122 takes the user to merchant add screen 130 in FIG. 7. Section 132 allows the user to copy data from an existing merchant. Section 134 allows new merchant information to be entered such as merchant number, association, standard industry codes (SIC), billing method, demand deposit account (DDA) and TR. Section 136 has data entry windows for DBA name and address.

The data entry process as described for merchant add screen 130, as well as other data entry screens described below, allows the merchant to provide all necessary business and financial data. Since the data is stored on central database 106, the user can return at anytime to complete or correct the merchant data. Merchant data is never lost. Storing merchant data in central database 106 allows express processing module 30 to maintain an audit trail and track every change to the merchant account. Once all data entry is complete, the merchant data is compiled and formatted for transmission to the bank which in turn opens the merchant account for the merchant upon completion and approval of all data requirements.

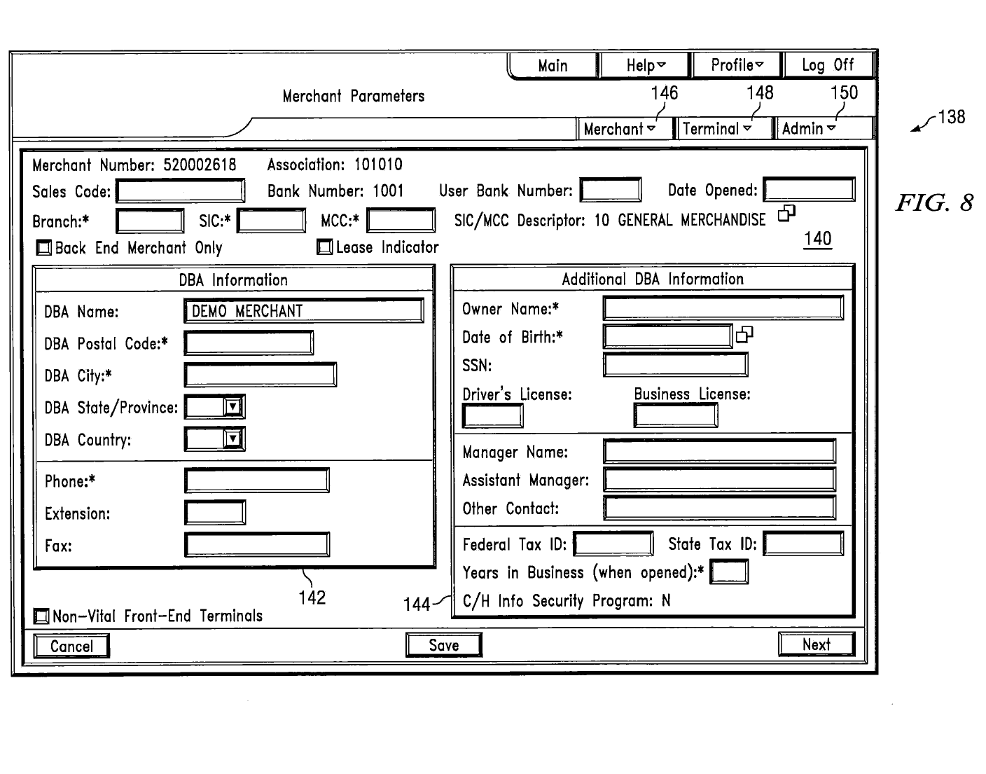

Next, the user is taken to merchant parameters screen 138 in FIG. 8. In section 140, merchant number and association are displayed. The data entry windows include sales code, bank number, user bank number, date opened, branch, SIC, merchant category code (MCC), back-end merchant only box, and lease indicator box. Section 142 allows the user to enter DBA information such as DBA name, DBA address, and DBA phone and fax numbers. Section 144 provides data entry windows for additional DBA information such as owner name, date of birth, social security number, driver's license, business license, manager contact, and tax information. Merchant parameter screen 138 further provides pull-down windows for merchant functions 146, terminal functions 148, and admin functions 150.

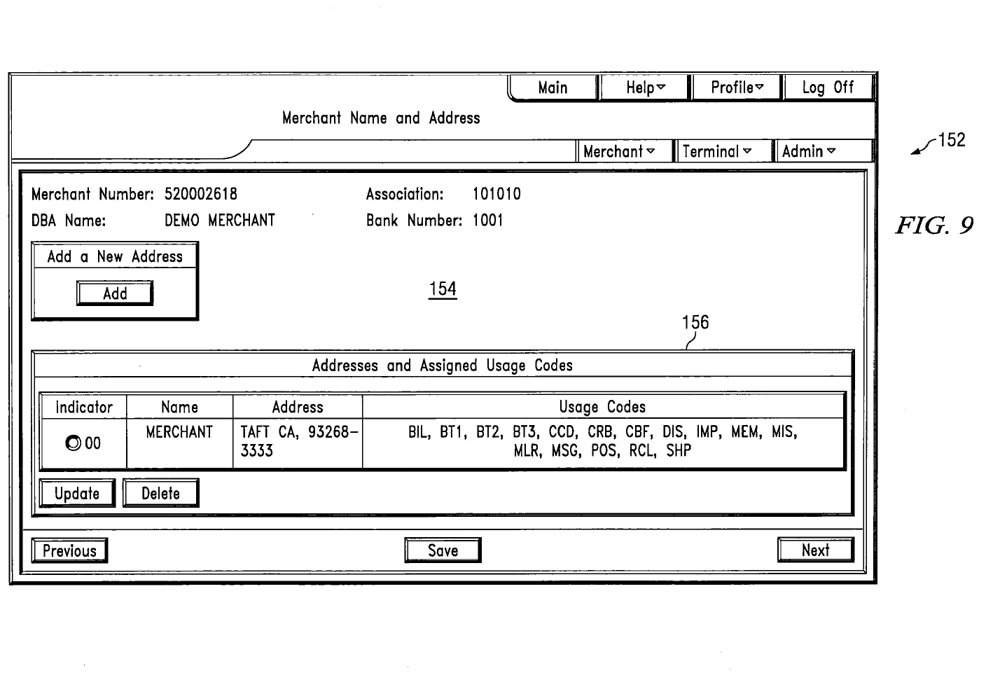

FIG. 9 illustrates a data entry screen 152 for merchant name and address. Section 154 shows current merchant information. Section 156 allows selection of merchant address and assigned usage codes.

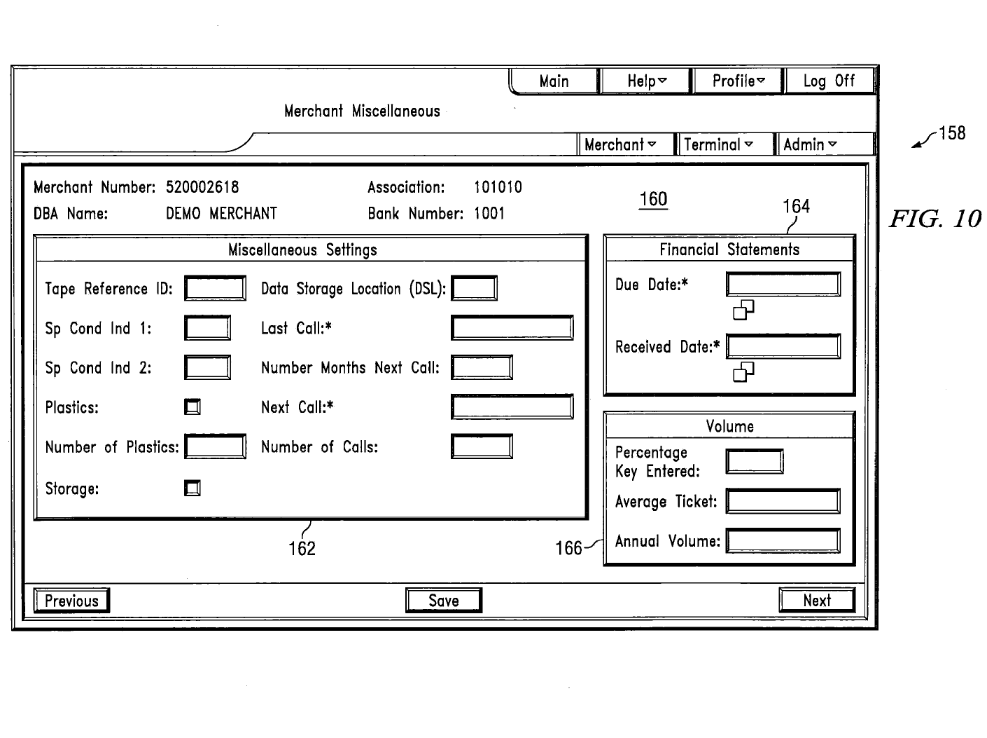

FIG. 10 illustrates a data entry screen 158 for miscellaneous merchant information. Section 160 shows current merchant information. Section 162 allows for miscellaneous settings such as tape reference ID, special condition indicators, plastics, storage, and call information. Section 164 has due date and receive date for financial statements. Section 166 is for volume, i.e., percent key entered, average ticket, and annual volume.

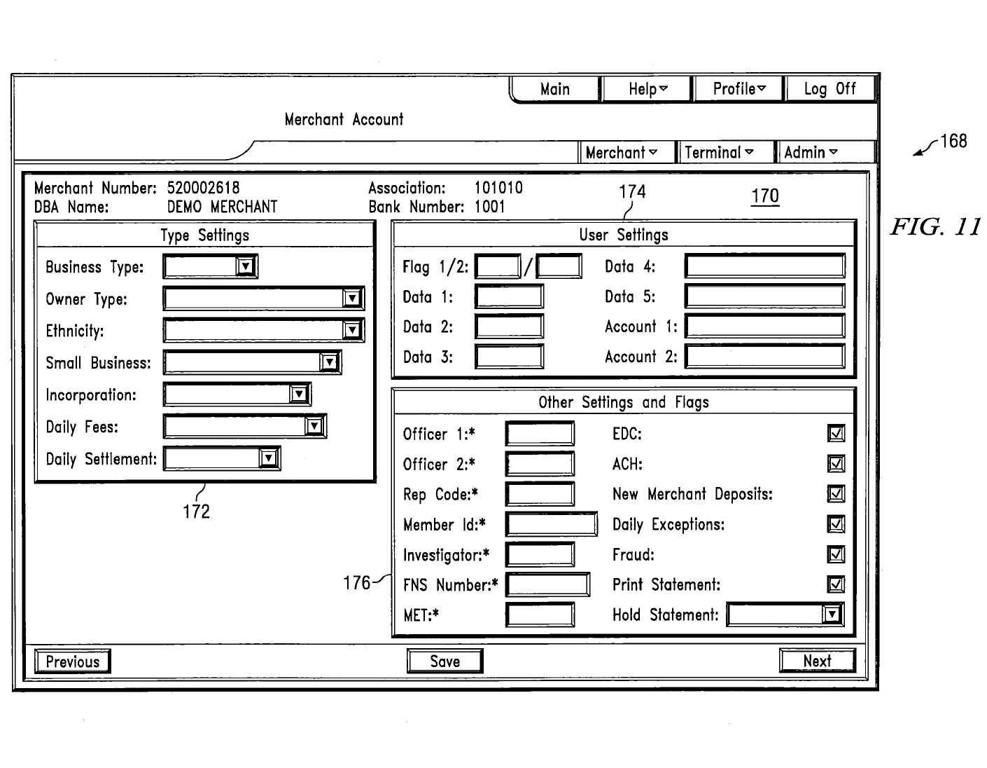

FIG. 11 illustrates a data entry screen 168 for merchant account information. Section 170 shows current merchant information. Section 172 allows for various type settings such as business type, owner type, ethnicity, small business, incorporation, daily fees, and daily settlement. Section 174 has user settings for flags, data, and accounts. Section 176 is for other settings and flags, i.e., officer, rep code, member ID, investigator, FNS, MET, EDC, ACH, merchant deposits, daily exceptions, fraud, and print statement.

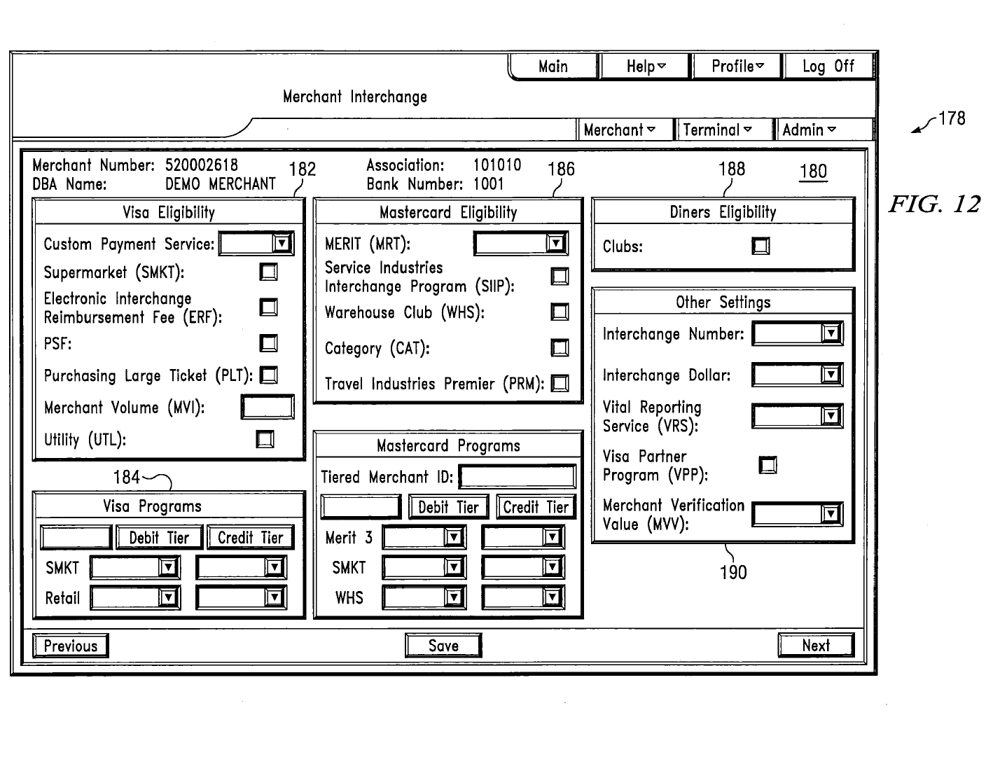

FIG. 12 illustrates a data entry screen 178 for merchant interchange information. Section 180 shows current merchant information. Section 182 shows Visa® eligibility, e.g., custom payment service, supermarket, electronic interchange reimbursement fee, PSF, purchasing large ticket, merchant volume, and utility. Section 184 shows Visa® programs for supermarket and retail. Section 186 shows Mastercard® eligibility, e.g., merit, service industries interchange program, warehouse club, category, and travel industries premier. Section 188 shows Diners eligibility. Section 190 has other settings for interchange number, interchange dollars, vital reporting services, Visa® partner program, and merchant verification value.

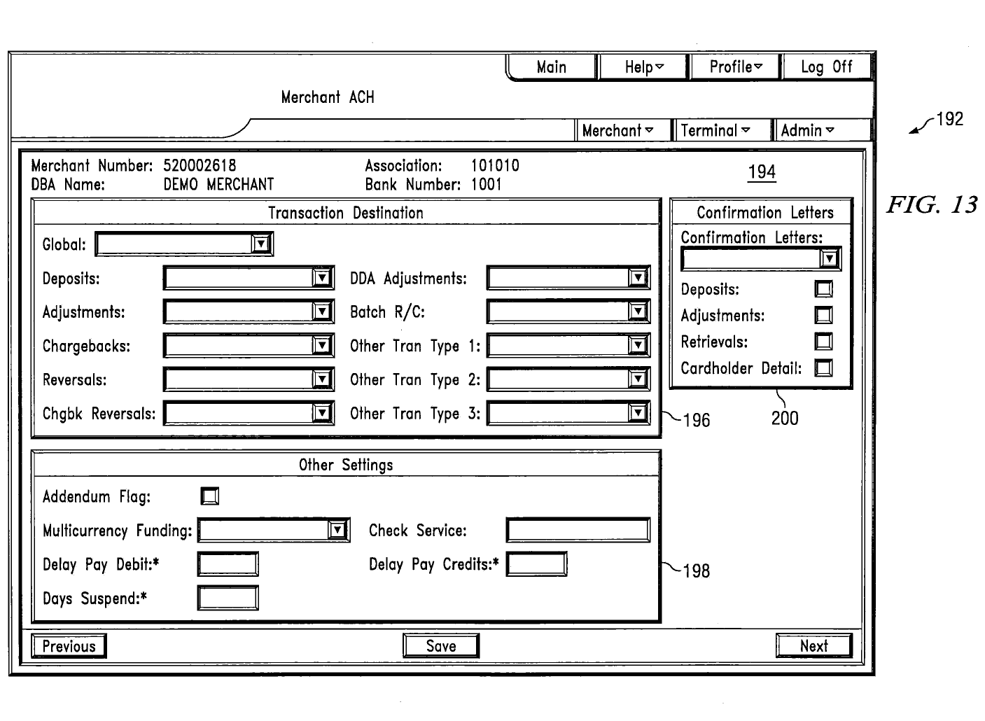

FIG. 13 illustrates a data entry screen 192 for merchant automated clearing house (ACH) information. Section 194 shows current merchant information. Section 196 shows transaction destination information such as global, deposits, adjustments, chargebacks, reversals, and batch. Section 198 shows other settings such as addendum flag, multi-currency funding, delay pay debits, days suspended, check service, and delay pay credits. Section 200 shows confirmation letters and flags for deposits, adjustments, retrievals, and cardholder detail.

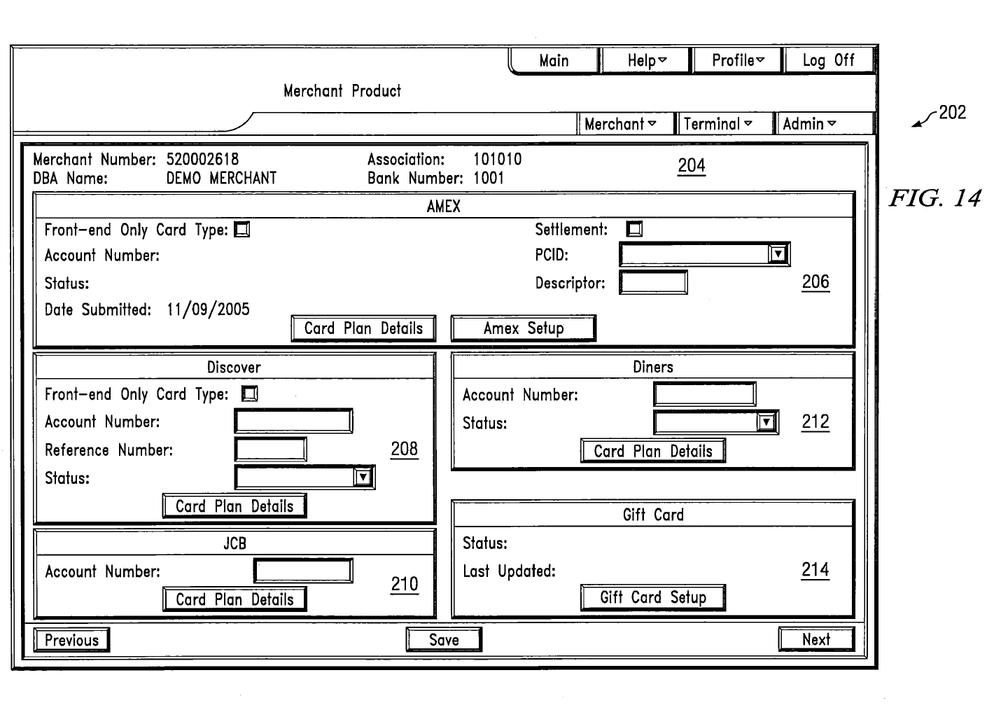

FIG. 14 illustrates a data entry screen 202 for merchant product information. Section 204 shows current merchant information. Section 206 shows American Express® (AMEX) card information such as front-end only card type, account number, status, date submitted, settlement, FCID, and descriptor. Section 208 shows Discover® card information such as front-end only card type, account number, reference number, and status. Section 210 shows JCB card information such as account number. Section 212 shows Diners® card information such as account number and status. Section 214 shows gift card information such as status and last updated.

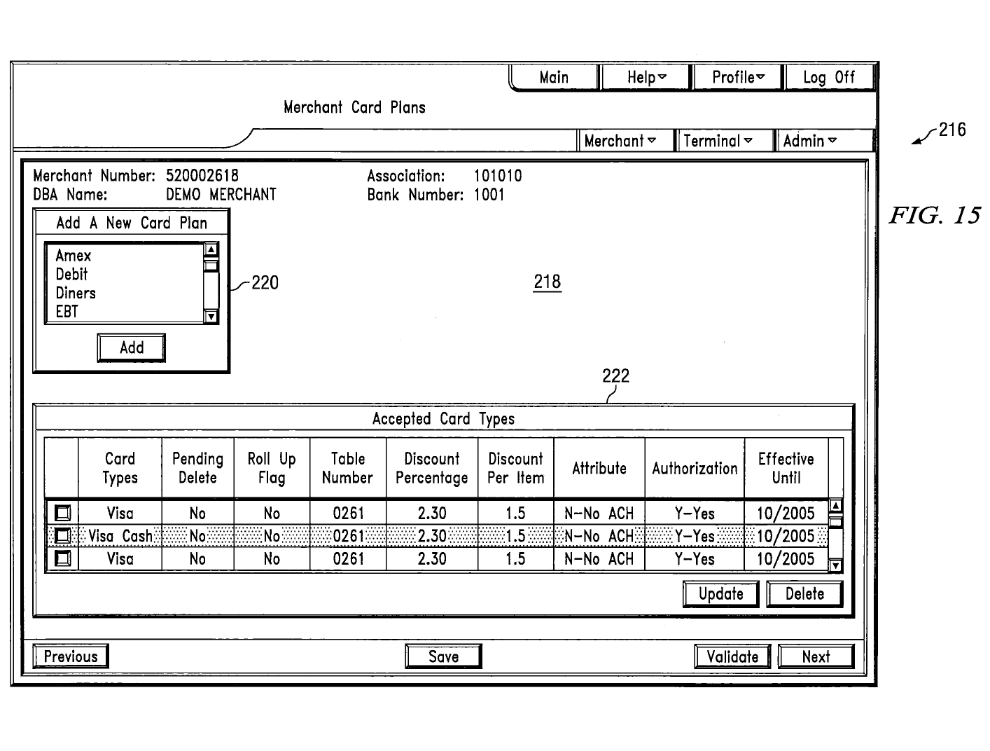

FIG. 15 illustrates a data entry screen 216 for merchant card plans. Section 218 shows current merchant information. Section 220 shows how to add a card plan, e.g., AMEX, Debit, Diners®, and EBT. Section 222 shows accepted card types, e.g., Visa® and Visa® Cash, with columns for pending delete, roll up flag, table number, discount percentage, discount per item, attribute, authorization, and effective until date.

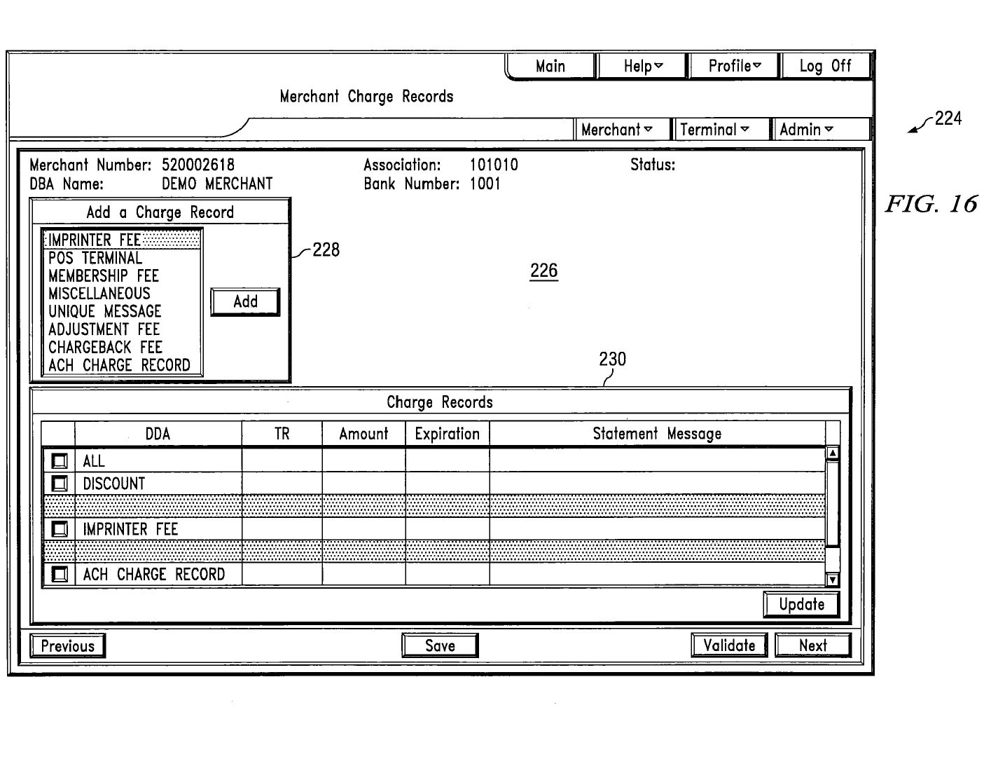

FIG. 16 illustrates a data entry screen 224 for merchant charge records. Section 226 shows current merchant information. Section 228 shows how to add a charge record, e.g., imprinter fee, POS terminal, membership fee, miscellaneous, unique message, adjustment fee, chargeback fee, and ACH chargeback record. Section 230 shows various charge records with columns for DDA, TR, amount, expiration, and statement message.

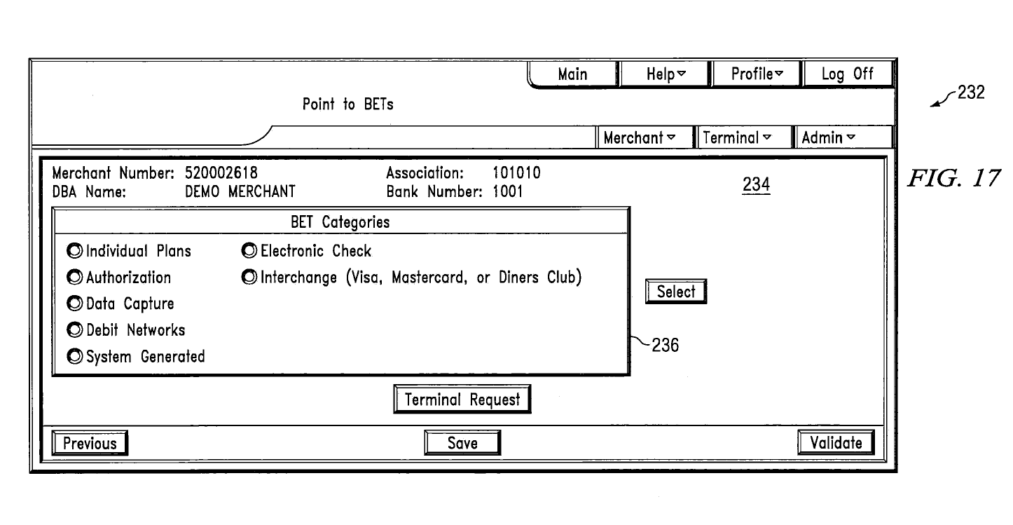

FIG. 17 illustrates a data entry screen 232 for merchant point to BET. Section 234 shows current merchant information. Section 236 shows various BET categories such as individual plans, authorization, data capture, debit networks, system generated, electronic check, and interchange.

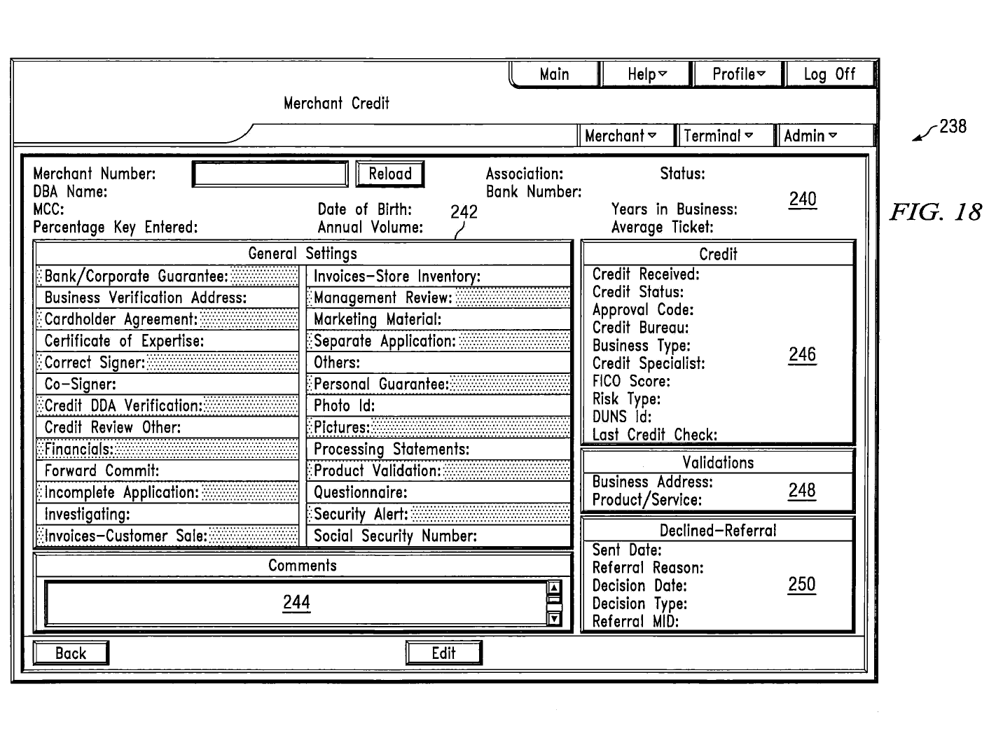

FIG. 18 illustrates a data entry screen 238 for merchant credit. Section 240 shows current merchant information such as merchant number, DBA name, MCC, percentage key entered, data of birth, annual volume, association, bank number, status, years in business, and average ticket. Section 242 shows general settings, i.e., bank/corporate guarantee, business verification address, cardholder agreement, certificate of expertise, correct signer, co-signer, credit DDA verification, credit review, financials, forward commit, incomplete application, investigating, invoices, management review, marketing material, separate application, personal guarantee, photo ID, pictures, processing statements, product validation, questionnaire, security alert, and social security number. Section 244 is provided for comments. Section 246 shows credit information such as credit received date, credit status, approval code, credit bureau, business type, credit specialist, FICO score, risk type, DUNS ID, and last credit check. Section 248 shows validation information such as business address and product/services. Section 250 shows declined and referral information, e.g., sent date, referral reason, decision date, decision type, and referral MID.

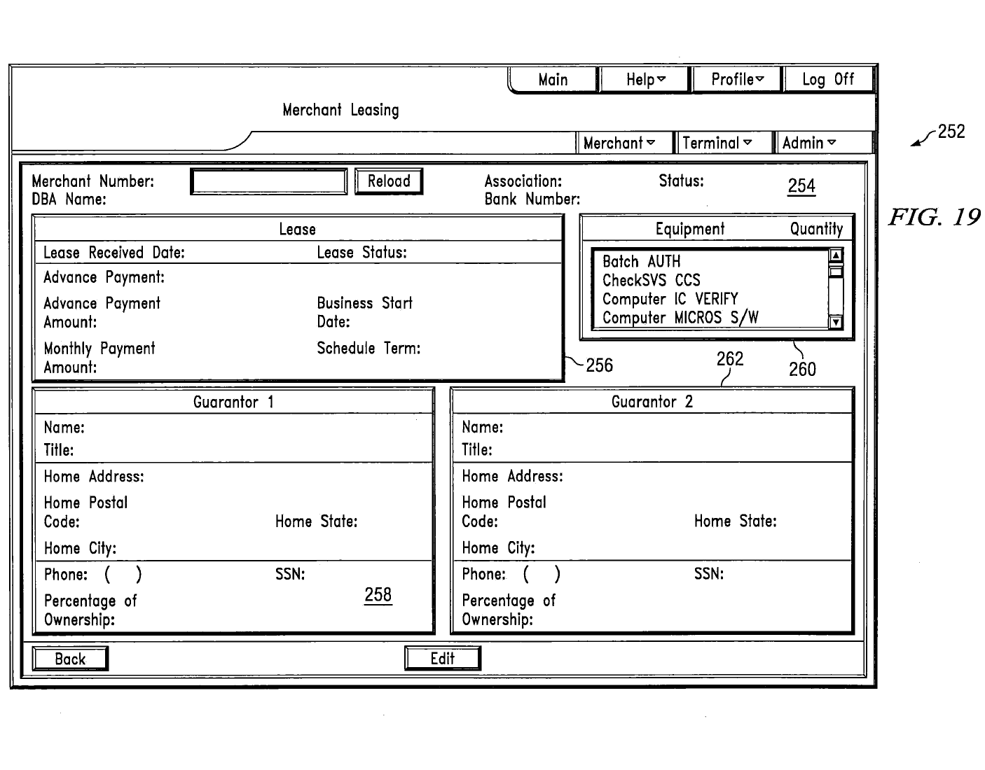

FIG. 19 illustrates a data entry screen 252 for merchant leasing. Section 254 shows current merchant information such as merchant number, DBA name, association, bank number, and status. Section 256 shows leasing information such as lease received date, advance payment, monthly payment, lease status, business start date, and schedule term. Sections 258 and 262 show guarantor information like name, title, address, phone, and percent ownership. Section 260 shows lease equipment, e.g., batch authorization, checksvs CCS, computer IC verify, and computer MICROS S/W.

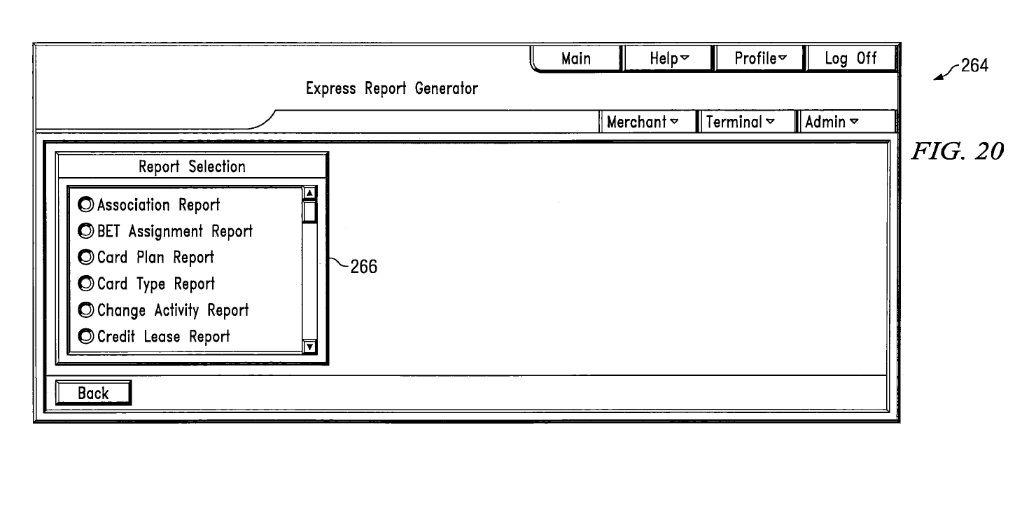

FIG. 20 illustrates a data entry screen 264 for express report generator. Section 266 shows various reports such as association report, BET assignment report, card plan report, card type report, change activity report, and credit lease report.

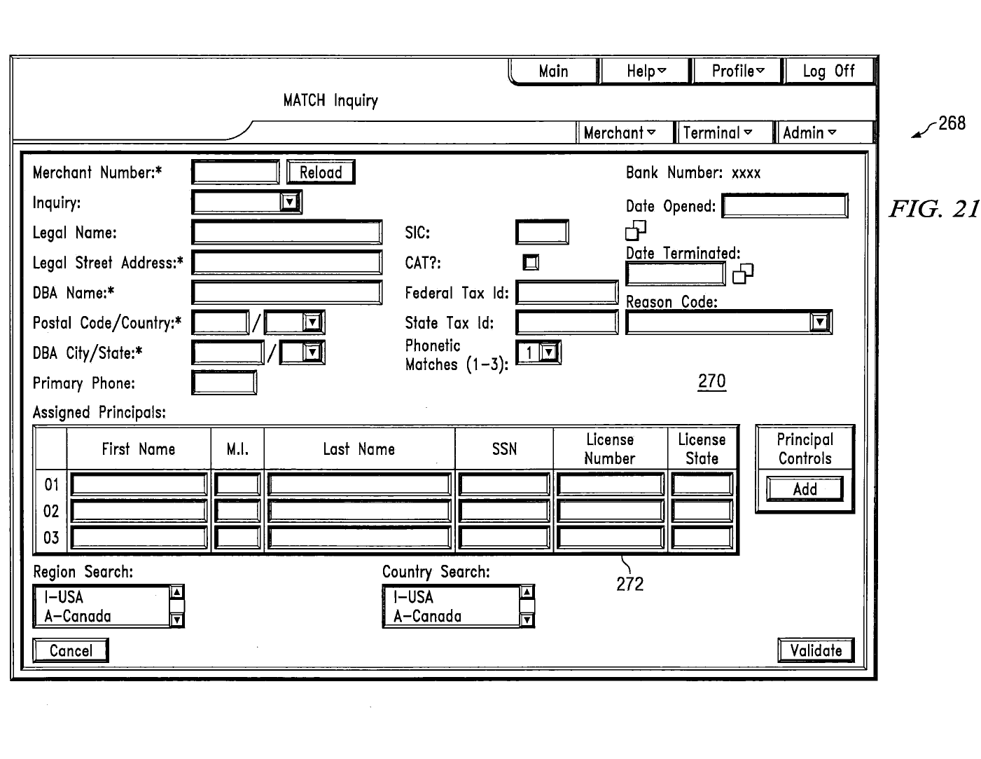

FIG. 21 illustrates a data entry screen 268 for merchant match inquiry. Section 270 shows search selections like merchant number, inquiry, legal name, legal address, DBA name, DBA address, phone, SIC, CAT, tax information, bank number, date opened, date terminated, and reason code. Section 272 shows assigned principals with column for first name, middle initial, last name, social security number, license number, and license state.

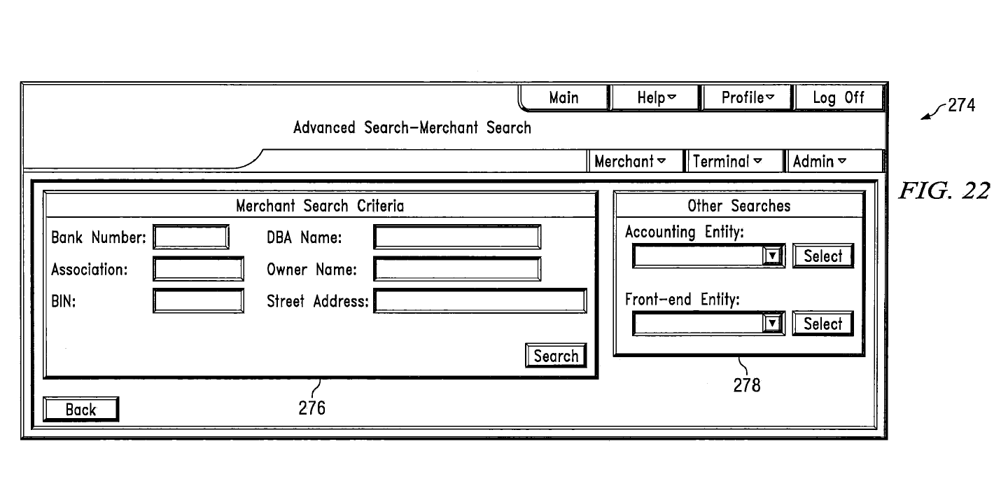

FIG. 22 illustrates a data entry screen 274 for advanced merchant search. Section 276 shows merchant search criteria for bank number, association, BIN, DBA name, owner name, and address. Section 278 provides for other searches such as accounting entity and front-end entity.

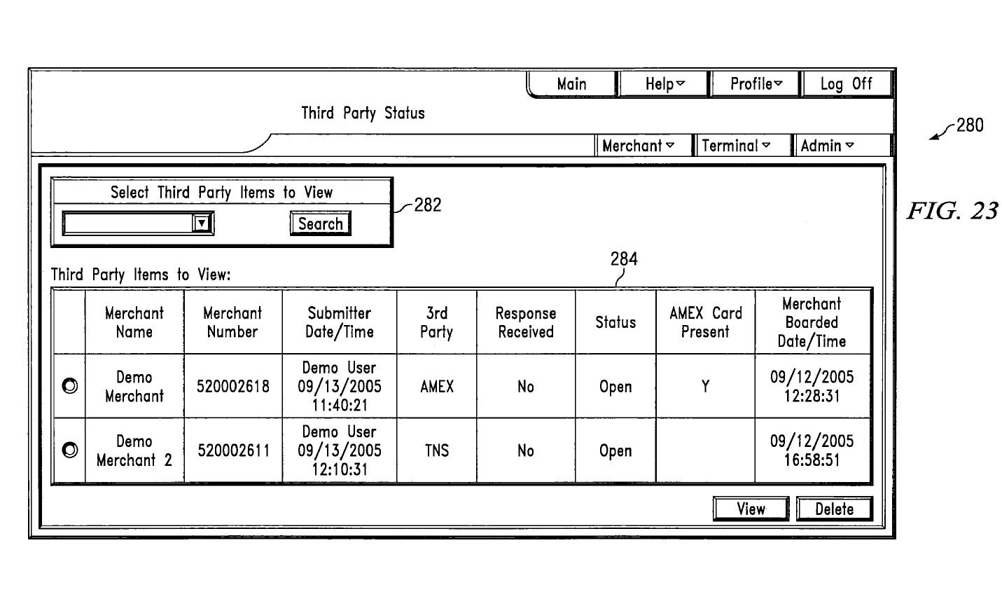

FIG. 23 illustrates a data entry screen 280 for third party status. Section 282 allows the user to select third party items to view. Section 284 shows the third party items selected for viewing with columns for merchant name, merchant number, submitter date/time, third party, response received, status, AMEX card present, and merchant boarded date/time.

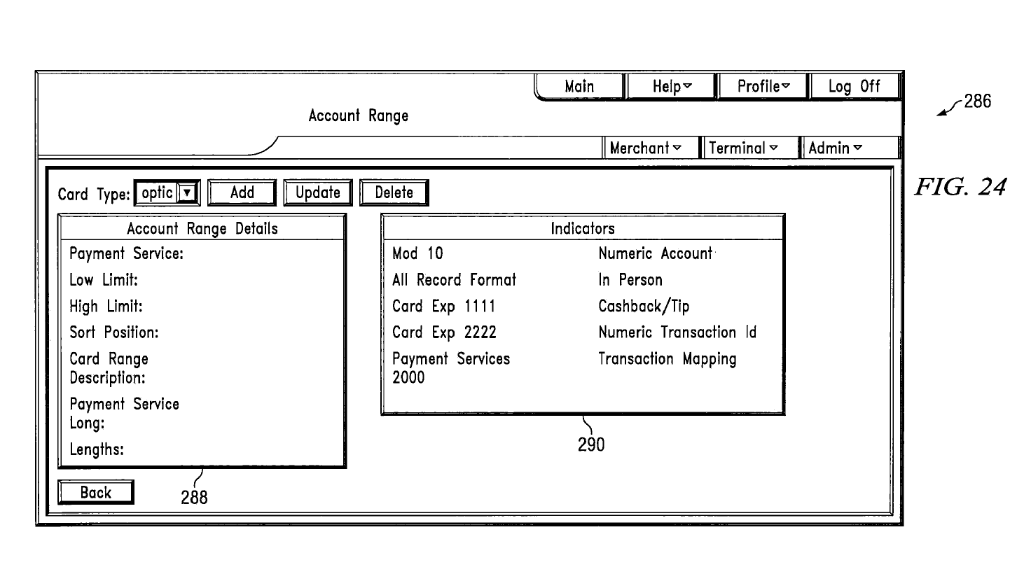

FIG. 24 illustrates a data entry screen 286 for merchant account range. Section 288 shows the account range details like payment service, low limit, high limit, sort position, card range description, payment service long, and lengths. Section 290 provides for account indicators such as mod 10, all record format, card expiration, payment services, numeric account, in person, cashback/tip, numeric transaction ID, and transaction mapping.

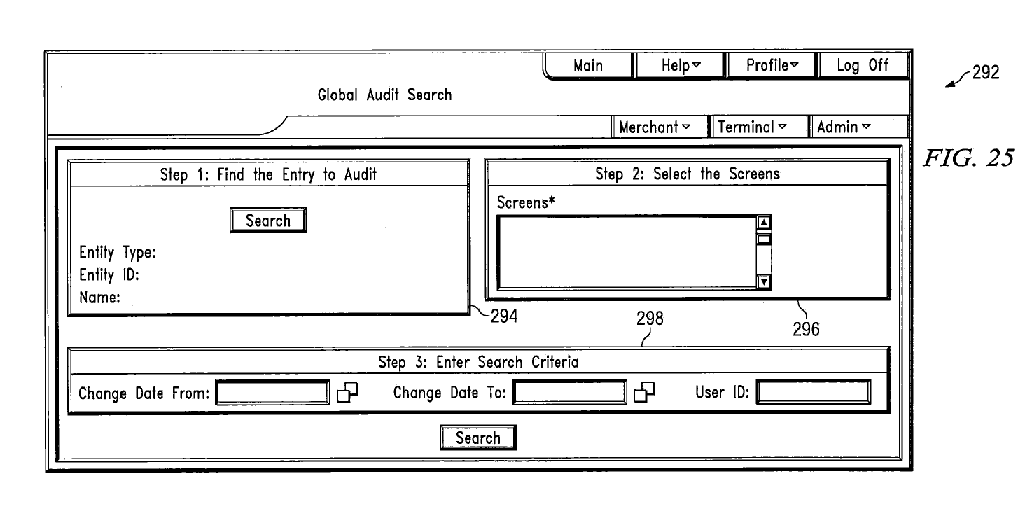

FIG. 25 illustrates a data entry screen 292 for global audit search. Section 294 allows the user to find the entity to audit using entity type, entity ID, and name. Section 296 allows the user to select various audit screens, e.g., merchant hierarchy, merchant demographics, merchant plans, merchant billing rates. Section 298 allows the user to enter search criteria such as change date from, change date to, and user ID.

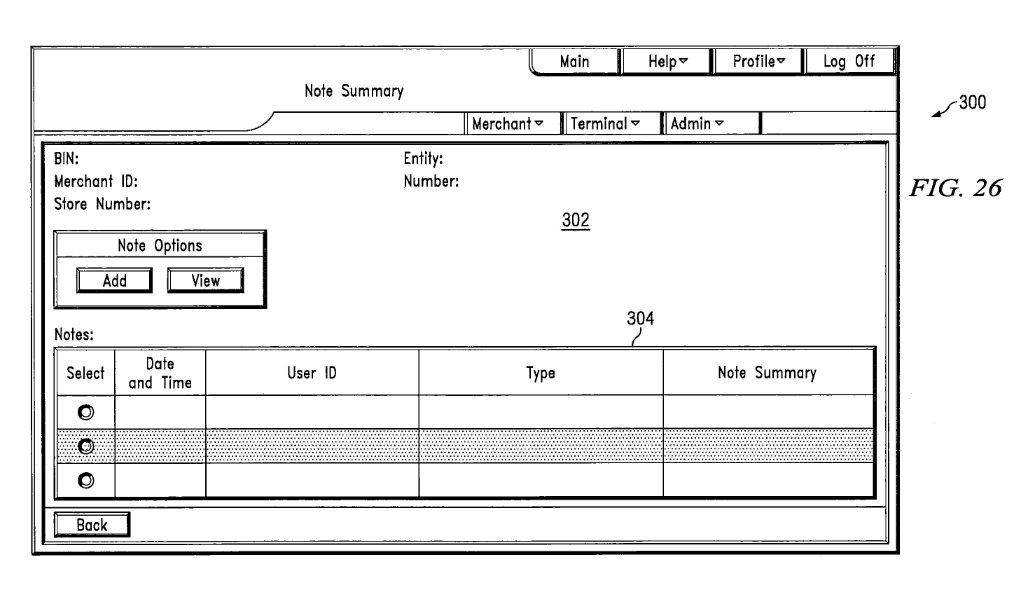

FIG. 26 illustrates a data entry screen 300 for merchant note summary. Section 302 shows merchant information such as BIN, merchant ID, store number, and entity. Section 304 displays the merchant notes with columns for date and time, user ID, type, and note summary.

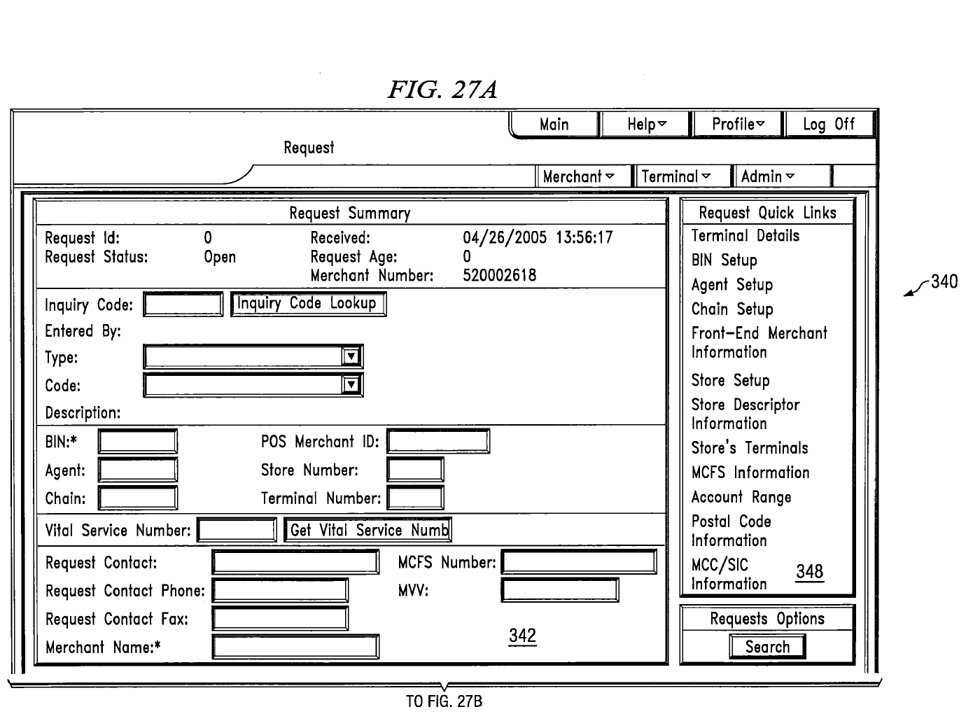

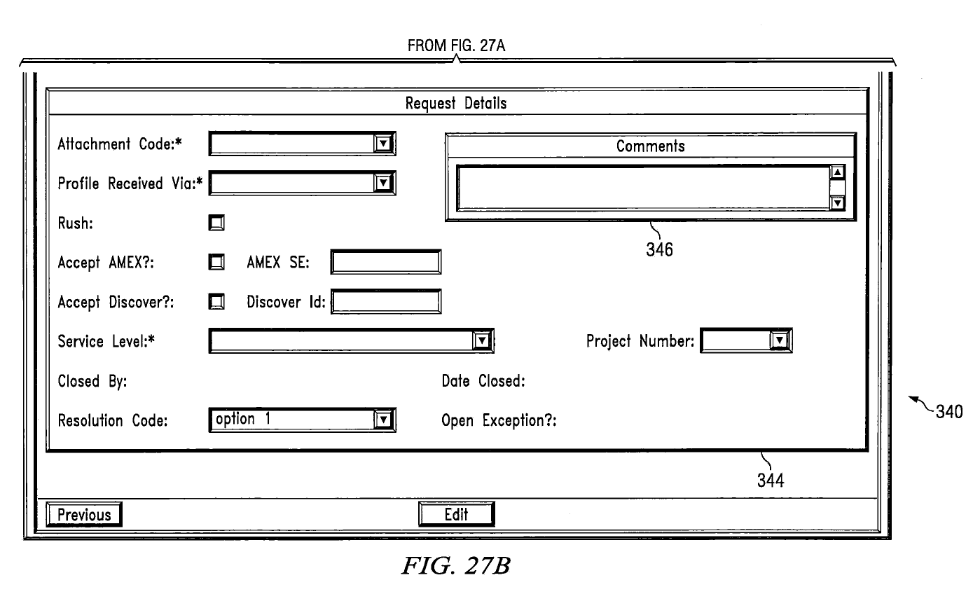

FIG. 27 illustrates a data entry screen 340 for merchant terminal request. Section 342 provides for terminal request summary based on inquiry code, BIN, agent, chain, POS merchant ID, store number, terminal number, and service number. Section 344 shows terminal request details such as attachment code, profile, service level, and project number. Block 346 is a comment box. Section 348 contains links to other data entry screens.

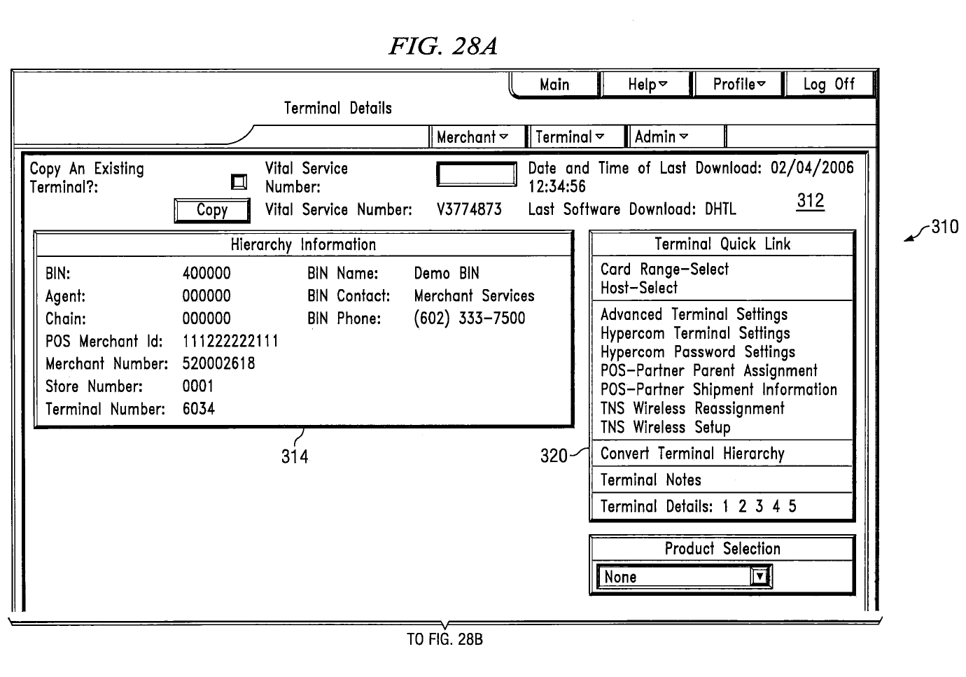

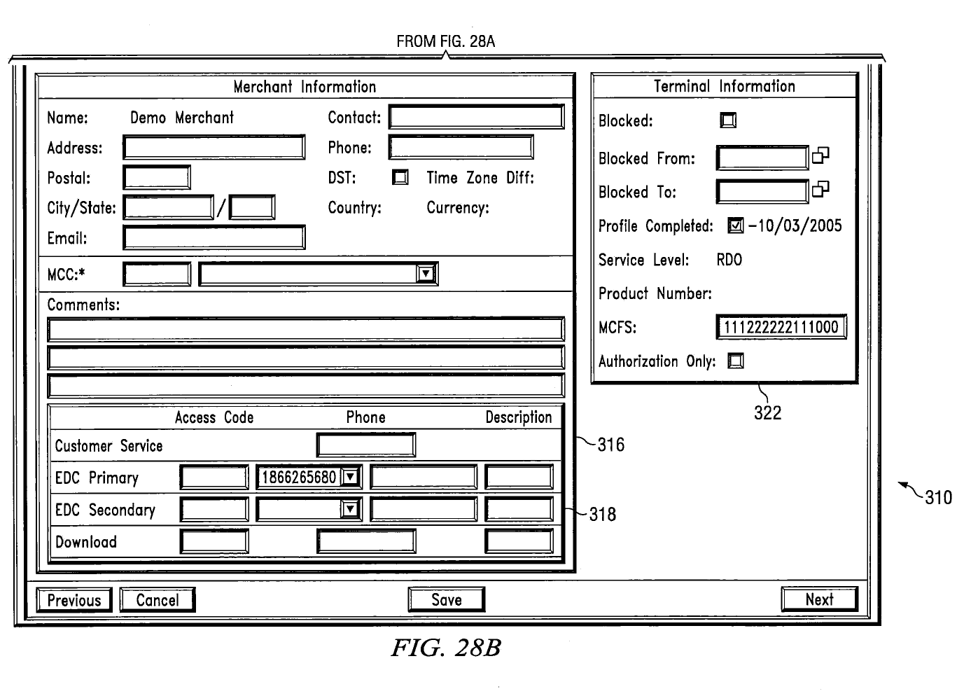

FIG. 28 illustrates a data entry screen 310 for merchant terminal details. Section 312 provides service number and date of last download. Section 314 shows hierarchy information such as BIN, agent, chain, POS merchant ID, merchant number, store number, terminal number, BIN name, and BIN contact. Section 316 shows merchant information such as name, address, contact, and MCC. Section 318 contains access codes. Section 320 contains links to other data entry screens. Section 322 shows terminal information such as blocked, profile, service level, project number, and MCFS.

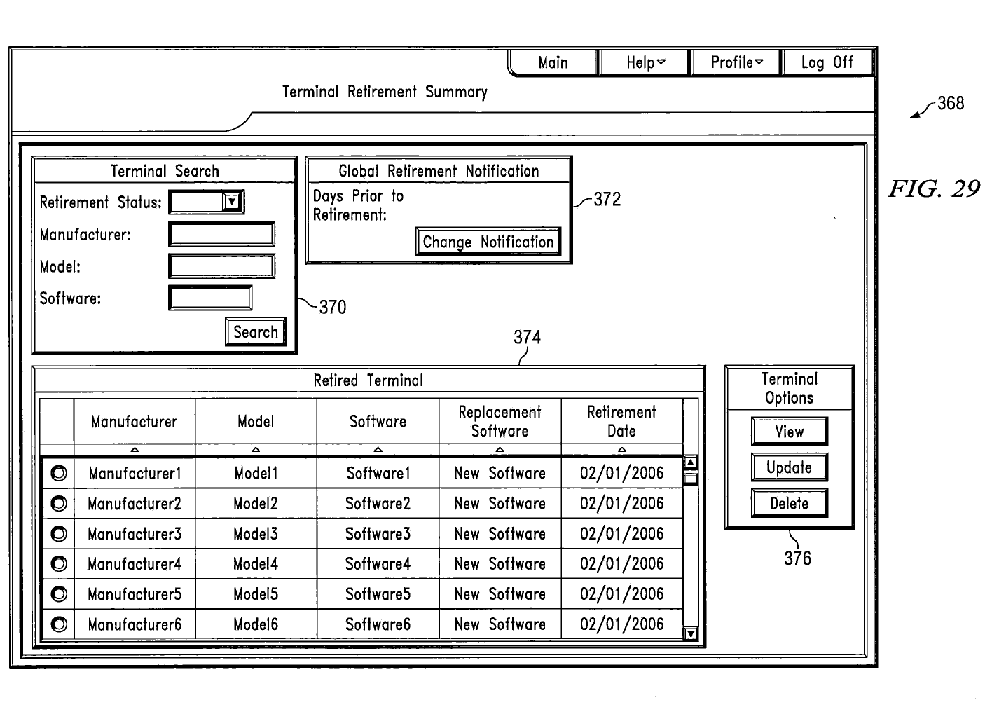

FIG. 29 illustrates a data entry screen 368 for merchant terminal retirement summary. Section 370 provides for a terminal search based on retirement status, manufacturer, model, and software. Section 372 shows a global retirement notification. Section 374 shows retired terminals with columns for manufacturer, model, software, replacement software, and retirement date. Section 376 shows terminal options of view, update, and delete.

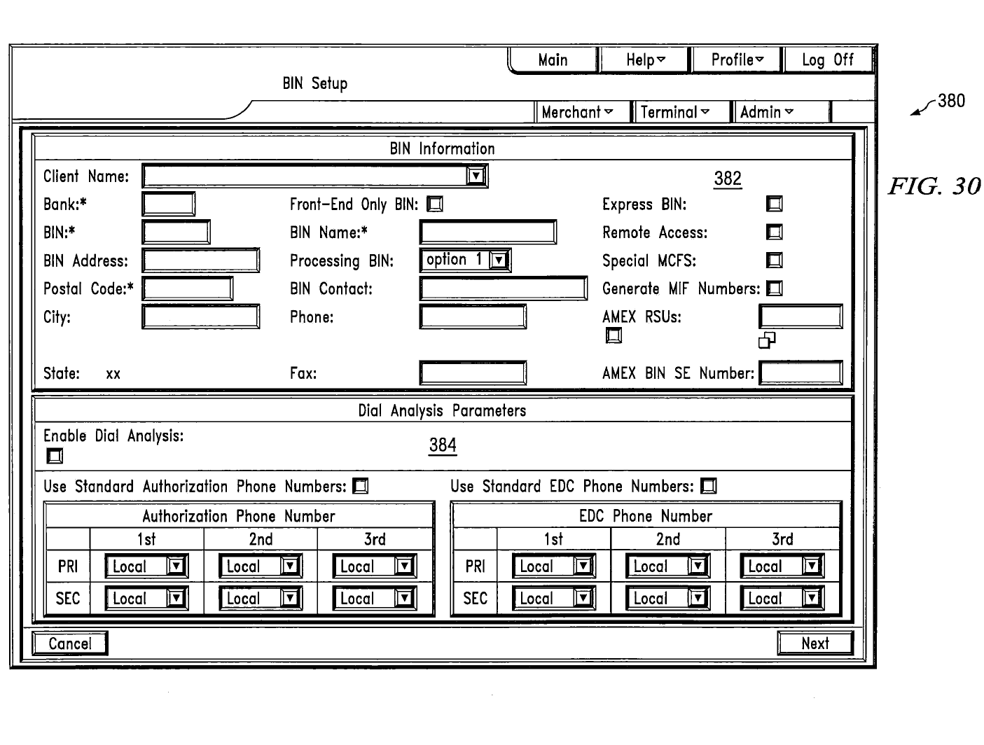

FIG. 30 illustrates a data entry screen 380 for BIN setup. Section 382 provides for BIN information such as client name, bank, BIN, address, BIN name, and contact. Section 384 shows dial analysis parameters.

Express processing module 30 handles applications for many merchants and many different banks. Each application must be entered into the module and then becomes a work in queue until complete. Express processing module 30 has the ability to create, edit, and manage applications and does so by placing them in a work queue. The work queue has certain work in process, i.e., application not yet complete. The work in process can be assigned to resources to work toward completing the application. For example, the third-party service provider managing express processing module 30 may assign workers to follow-up with the merchant to complete missing parts of the application. Workers may be assigned responsibility and authorized to work on different parts of the application. Consequently, the worker who starts the application may not be the worker who finishes the application. The work queue gives the third-party service provider flexibility in managing and completing the applications.

Take an example of the work queue in operation. Acquiring bank 24 makes application for merchant 20 for an account in order to transact credit card purchases. Acquiring bank 24 provides preliminary information to express processing module 30. Acquiring bank 24 may not have all merchant information at the time. The merchant is informed of the missing information. The merchant data is stored in database 106 while merchant 20 gathers the additional information. The application (work in process) remains in queue until the acquiring bank obtains the additional information. When the information is available, the application is retrieved from database 106 and a resource is assigned to continue processing the application. Some of the work in process is awaiting information or approvals from the bank. In any case, the merchant's application remains in queue and is assigned resources when there is work to be done until the application is complete.

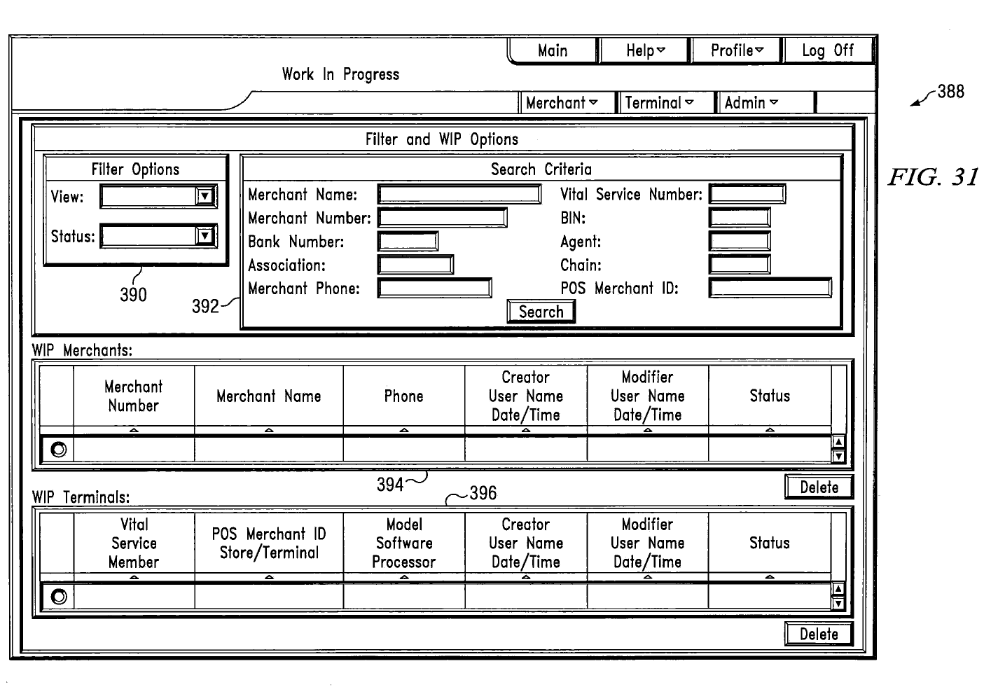

FIG. 31 illustrates a data entry screen 388 for work in progress. Section 390 provides for filter options of view and status. Section 392 provides for search criteria including merchant name, merchant number, bank number, association, phone, vital service number, BIN, agent, chain, and POS merchant ID. Section 394 shows work in process merchants with columns for merchant number, merchant name, phone, creator user name date/time, modifier user name date/time, and status. Section 396 shows work in process terminals with columns for vital service number, POS merchant ID store/terminal, model software processor, creator user name date/time, modifier user name date/time, and status. Data entry screen 388 allows the administrators of express processing module 30 to oversee the work queue and assign resources when appropriate to keep the application moving forward as quickly and efficiently as possible.

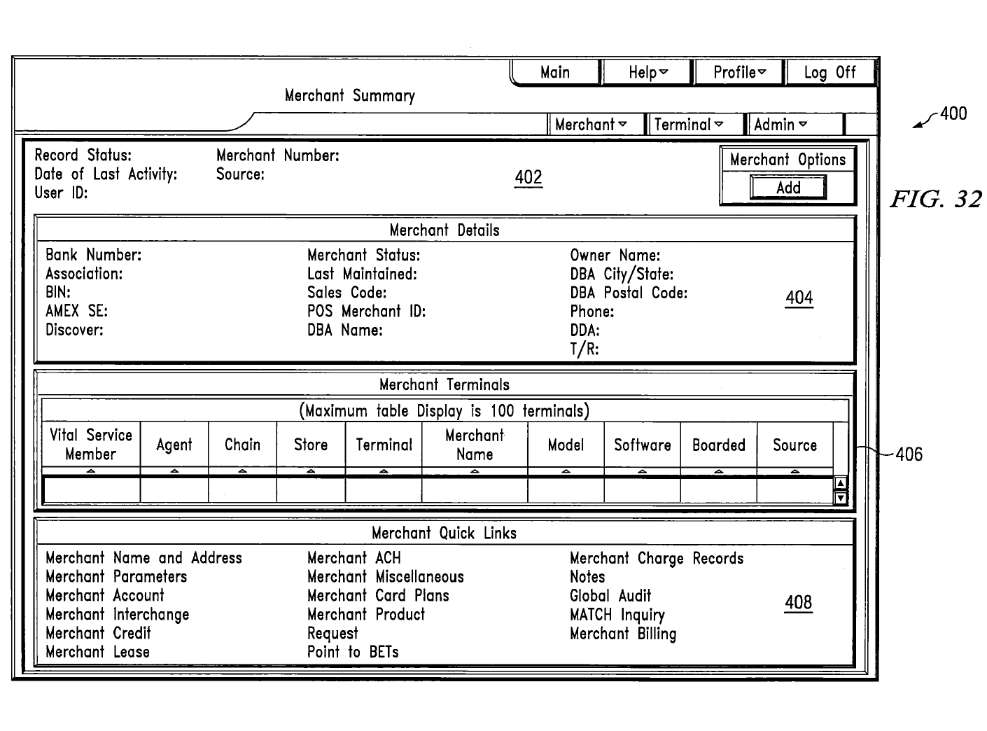

FIG. 32 illustrates a data entry screen 400 for merchant summary. Section 402 provides for general merchant information such as record status, date of last activity, user ID, merchant number, and source. Section 404 shows more merchant details like bank number, association, BIN, AMEX SE, Discover®, merchant status, last maintained date, sales code, POS merchant ID, DBA name, owner name, DBA address, phone DDA, and TR. Section 406 shows merchant terminals with columns for vital service number, agent, chain, store, terminal, merchant name, model, software, boarded, and source. Section 408 shows merchant quick links to other data entry screens such as merchant name and address, merchant parameters, merchant account, merchant interchange, merchant credit, merchant lease, merchant ACH, merchant miscellaneous, merchant card plans, merchant product, request, point to BETs, merchant charge records, notes, global audit, match inquiry, and merchant billing.

In summary, merchant makes application to open an account for terminal services to utilize credit card processing system 10. The merchant application is placed in queue. The merchant provides the business and financial information necessary to utilize all functions of credit card processing system 10. The merchant application remains in queue until complete. The application is either idle awaiting more information, or assigned a resource to continue processing. The express processing module simplifies and increases the efficiency of the data entry necessary to create and initialize the merchant account.

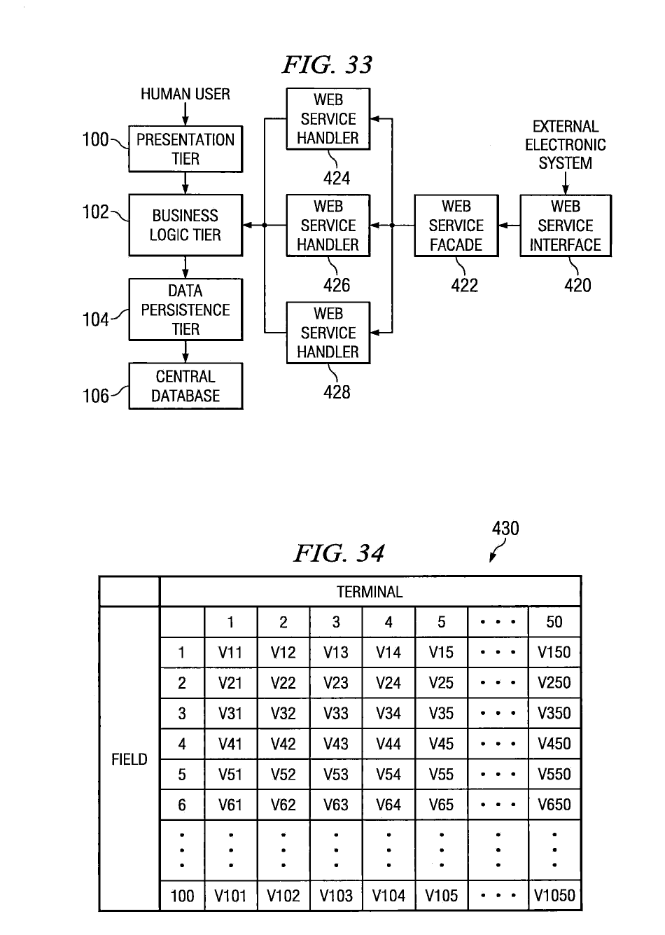

FIG. 33 illustrates a block diagram of the interface for various web services with external electronic systems, e.g. acquiring bank 24 or credit card association 34. Express processing module 30 allows external systems to communicate with its internal structure, e.g. business logic tier 102 from FIG. 5. The external electronic systems typically communicate via extensible markup language (XML) type files. The XML files contain data and request for information from express processing module 30. The XML files may contain a single transaction or request for information. Alternatively, the XML files may contain a batch of multiple transactions stacked for processing. Web services interface 420 receives XML files, or any other standard file type, and validates the file by checking its structure and content. Each bank may have different user interface, file type, workflow procedures, and business processes unique to the bank and not necessarily compatible with express processing module 30. Web services façade 422 performs authorization checking on the XML file. Express processing module 30 maintains a library of compatible file types for web services façade 422 to validate each incoming file. Web services façade 422 further manages the work flow between the internal processing of module 30 and the external electronic systems to prioritize the flow of requests and responses. A queuing feature manages the priority of the multiple transactions flowing into and out of express processing module 30.

Web service handlers 424, 426, and 428 perform the conversion from the XML file to object model compatible with express processing module 30. Each web service handler is configured for converting a particular external file type to an object model for the various component blocks of express processing module 30. For example, web service handler 424 may be configured to convert XML requests into an object model compatible with merchant management module 82. Web service handler 426 may be configured to convert another file type requests into an object model compatible with terminal management module 84. Web service handler 428 may be configured to convert yet another file type requests into an object model compatible with bank management system 90. This configuration is just one example; the web service handlers can be organized and configured to convert any supported external file type to any component block of express processing module 30.

The web service handlers connect to business logic tier 102 to receive the external systems transactions and requests. For example, acquiring bank 24 may send a request for information regarding a merchant application to express processing module 30. The request from the bank must be verified and converted to access the information in central database 106 as necessary to answer the query. The intelligence interface allows express processing module 30 to maintain its proprietary processing and still allow external systems access to needed information.

Business logic tier 102 can receive human input via presentation tier 100 or electronic input from the web services interface. Business logic tier 102 converts and processes either source of information to perform the function of express processing module 30. Business logic tier 102 can process individual transactions from presentation tier 100, or single real-time transaction or batch transactions from web services interface 420.

FIG. 34 illustrates table 430 for storing default information for various merchant terminals. The default values are useful for data entry consistency into express processing module 30. Terminals 1, 2, . . . 50 represent various types of terminals. Each terminal comes from a specific manufacturer and with specific configuration requirements. Fields 1, 2, . . . 100 represent the various field for each terminal. The values V11, V12, V13, V21, V22, V23 are default values or configuration data for each field of each terminal. Express processing module 30 can readily complete terminal fields once the user identifies the type of terminal they are using.

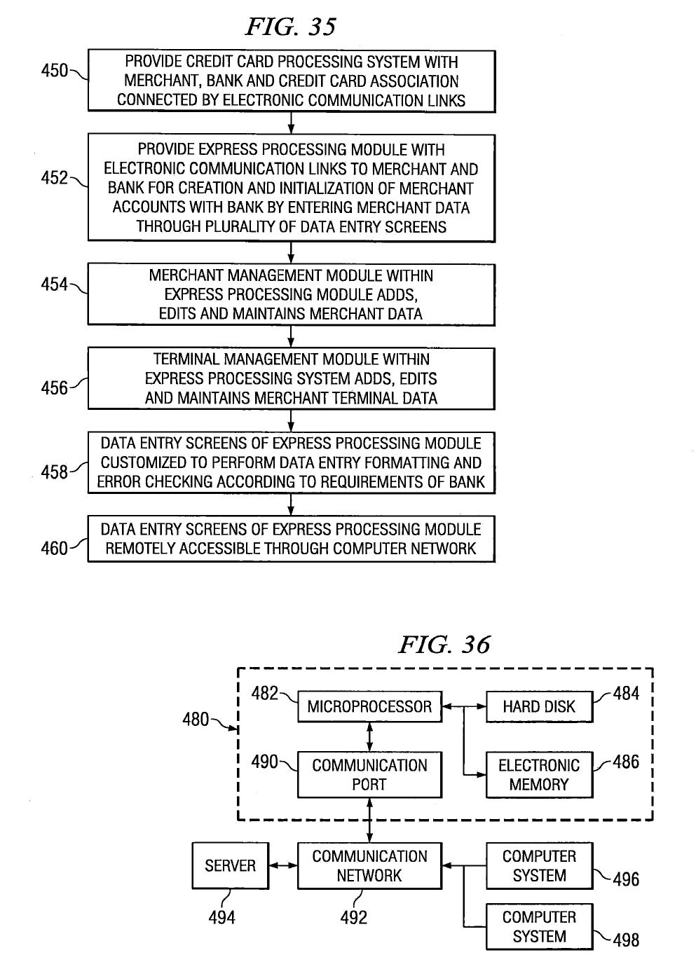

As further explanation, FIG. 35 illustrates a process flowchart of one embodiment of the method of express creation and initialization of merchant accounts. In step 450, a credit card processing system including a merchant, bank, and credit card association is connected by electronic communication links. In step 452, an express processing module is provided with electronic communication links to the merchant and bank. The express processing module provides for creation and initialization of merchant accounts with the bank by entering merchant data through a plurality of data entry screens within the express processing module. The merchant data is compiled and formatted for transmission to the bank which in turn opens the merchant accounts for the merchant upon completion and approval of all data requirements. In step 454, a merchant management module within the express processing module adds, edits, and maintains the merchant data. In step 456, a terminal management module within the express processing system adds, edits, and maintains merchant terminal data. The merchant management module and terminal management module each a presentation tier for interfacing with users and external systems, business logic tier for defining rules by which the merchant management module and terminal management module operate, and a data persistence tier for interfacing with a central database which stores the merchant data and merchant terminal data. In step 458, the data entry screens of the express processing module are customized to perform data entry formatting and error checking according to requirements of the bank. In step 460, the data entry screens of the express processing module are remotely accessible through a computer network.

FIG. 36 illustrates a simplified computer system 480 for executing the software program used in the express processing module 30. Computer system 480 is a general purpose computer including a central processing unit or microprocessor 482, mass storage device or hard disk 484, electronic memory 486, and communication port 490. Communication port 490 represents a modem, high-speed Ethernet link, or other electronic connection to transmit and receive input/output (I/O) data with respect to other computer systems.

Computer 480 is shown connected to communication network 492 by way of communication port 490, which in turn is connected to server 494. Server 494 operates as a system controller and includes mass storage devices, operating system, and communication links for interfacing with communication network 492. Communication network 492 can be a local and secure communication network such as an Ethernet network, global secure network, or open architecture such as the Internet. Computer systems 496 and 498 can be configured as shown for computer 480 or dedicated and secure data terminals. Computers 496 and 498 are also connected to communication network 492. Computers 480, 496, and 498 transmit and receive information and data over communication network 492.

When used as a standalone unit, computer 480 can be located in any convenient location. When used as part of a computer network, computers 480, 496, and 498 can be physically located in any location with access to a modem or communication link to network 492. For example, computer 480 can be located in the main office of the third party service provider for the express processing module. Computer 496 can be located in one department of the bank. Computer 498 can be located in another department of the bank. Alternatively, the computers can be mobile and follow the users to any convenient location, e.g., remote offices, customer locations, hotel rooms, residences, vehicles, public places, or other locales with electronic access to communication network 492.

Each of the computers runs application software and computer programs, which can be used to display user interface screens, execute the functionality, and provide the features of the express processing module as described above. In one embodiment, the screens and functionality come from the application software, i.e., the express processing module runs directly on one of the computer systems. Alternatively, the screens and functions are provided remotely from one or more websites on the Internet. In this case, the local computer is a portal to the express processing module running on a remote computer. The websites are generally restricted access and require passwords or other authorization for accessibility. Communications through the website may be encrypted using secure encryption algorithms. Alternatively, the screens are accessible only on the secure private network, such as Virtual Private Network (VPN), with proper authorization.

The software is originally provided on computer readable media, such as compact disks (CDs), magnetic tape, or other mass storage medium. Alternatively, the software is downloaded from electronic links such as the host or vendor website. The software is installed onto the computer system hard drive 484 and/or electronic memory 486, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. In the case of Internet-based websites, the interface screens are implemented as one or more webpages for receiving, viewing, and transmitting information related to the express processing module. A host service provider may set up and administer the website from computer 480 or server 494 located in the host service provider's home office. The employee accesses the webpages from computers 496 and 498 via communication network 492. The software contains one or more programming modules, subroutines, computer links, and compilations of executable code which perform the functions of the express processing module. The user interacts with the software via keyboard, mouse, voice recognition, and other user interface devices connected to the computer system.

The software stores information and data related to the express processing module in a database or file structure located on any one of, or combination of, hard drives 484 of the computers 480, 496, 498, and/or server 494. More generally, the information used in the express processing module can be stored on any mass storage device accessible to computers 480, 496, 498, and/or server 494. The mass storage device for storing the express processing module may be part of a distributed computer system.

Although the present invention has been described with respect to preferred embodiments, any person skilled in the art will recognize that changes be made in form and detail, and equivalents may be substituted for elements of the invention without departing from the spirit and scope of the invention. Many modifications may be made to adapt to a particular situation or material to the teaching of the invention without departing from the essential scope of the invention. Therefore, it is intended that the invention not be limited to the particular embodiments disclosed for carrying out this invention, but that the invention will include all embodiments falling within the scope of the appended claims.

What is claimed is:

1. A computer-implemented method of express creation and initialization of merchant accounts, comprising:
providing a credit card processing system including a merchant, bank, and credit card association connected by electronic communication links; and
providing an express processing module with electronic communication links to the merchant and bank, wherein the express processing module provides for creation and initialization of merchant accounts with the bank for the benefit of the merchant by entering merchant data through a plurality of data entry screens within the express processing module, the merchant data being compiled and formatted for transmission to the bank which in turn opens the merchant accounts upon completion and approval of all data requirements.

2. The computer-implemented method of claim 1, wherein providing the express processing module includes the steps of:
providing a merchant management module for adding, editing, and maintaining the merchant data; and
providing a terminal management module for adding, editing, and maintaining merchant terminal data.

3. The computer-implemented method of claim 2, wherein providing the merchant management module and terminal management module each include the steps of:
providing a presentation tier for interfacing with users and external systems;
providing a business logic tier for defining rules by which the merchant management module and terminal management module operate; and
providing a data persistence tier for interfacing with a central database which stores the merchant data and merchant terminal data.

4. The computer-implemented method of claim 1, wherein the data entry screens of the express processing module are customized to perform data entry formatting and error checking according to requirements of the bank.

5. The computer-implemented method of claim 1, wherein the data entry screens of the express processing module are remotely accessible through a computer network.

6. A computer-implemented method of express creation and initialization of merchant accounts, comprising:
providing a credit card processing system including a merchant and bank connected by an electronic communication link; and
providing an express processing module with electronic communication links to the merchant and bank, wherein the express processing module provides for creation and initialization of merchant accounts with the bank for the benefit of the merchant by entering merchant data through a plurality of data entry screens within the express processing module, the merchant data being compiled and formatted for transmission to the bank which in turn opens the merchant account upon completion and approval of all data requirements.

7. The computer-implemented method of claim 6, wherein providing the express processing module includes the steps of:
providing a merchant management module for adding, editing, and maintaining the merchant data; and
providing a terminal management module for adding, editing, and maintaining merchant terminal data.

8. The computer-implemented method of claim 7, wherein providing the merchant management module and terminal management module each include the steps of:
providing a presentation tier for interfacing with users and external systems;
providing a business logic tier for defining rules by which the merchant management module and terminal management module operate; and
providing a data persistence tier for interfacing with a central database which stores the merchant data and merchant terminal data.

9. The computer-implemented method of claim 6, wherein the data entry screens of the express processing module are customized to perform data entry formatting and error checking according to requirements of the bank.

10. The computer-implemented method of claim 6, wherein the data entry screens of the express processing module are remotely accessible through a computer network.

11. A computer-implemented method of express creation and initialization of accounts, comprising:
providing a processing system including a plurality of components connected by electronic communication links; and
providing an express processing module with electronic communication links to the plurality of components, wherein the express processing module provides for creation and initialization of accounts with a first component for the benefit of a second component by entering data through a plurality of data entry screens within the express processing module, the data being compiled and formatted for transmission to the first component which in turn opens the account for the second component upon completion and approval of all data requirements.

12. The computer-implemented method of claim 11, wherein providing the express processing module includes the steps of providing a management module for adding, editing, and maintaining the data.

13. The computer-implemented method of claim 12, wherein providing the management module includes the steps of:
providing a presentation tier for interfacing with users and external systems;
providing a business logic tier for defining rules by which the management module operates; and
providing a data persistence tier for interfacing with a central database which stores the data.

14. The computer-implemented method of claim 11, wherein the data entry screens of the express processing module are customized to perform data entry formatting and error checking according to requirements of the first component.

15. The computer-implemented method of claim 11, wherein the data entry screens of the express processing module are remotely accessible through a computer network.

16. A computer program product usable with a programmable computer processor having a computer readable program code embodied therein, comprising:
computer readable program code which interacts with a credit card processing system including a merchant and bank connected by an electronic communication link; and
computer readable program code which establishes an express processing module with electronic communication links to the merchant and bank, wherein the express processing module provides for creation and initialization of merchant accounts with the bank for the benefit of the merchant by entering merchant data through a plurality of data entry screens within the express processing module, the merchant data being compiled and formatted for transmission to the bank which in turn opens the merchant account upon completion and approval of all data requirements.

17. The computer program product of claim 16, wherein the express processing module includes:
a merchant management module for adding, editing, and maintaining the merchant data; and
a terminal management module for adding, editing, and maintaining merchant terminal data.

18. The computer program product of claim 17, wherein the merchant management module and terminal management module each include:
a presentation tier for interfacing with users and external systems;
a business logic tier for defining rules by which the merchant management module and terminal management module operate; and
a data persistence tier for interfacing with a central database which stores the merchant data and merchant terminal data.

19. The computer program product of claim 16, wherein the data entry screens of the express processing module are customized to perform data entry formatting and error checking according to requirements of the bank.

20. A computer system for express creation and initialization of merchant accounts, comprising:
means for providing a credit card processing system including a merchant and bank connected by an electronic communication link; and
means for providing an express processing module with electronic communication links to the merchant and bank, wherein the express processing module provides for creation and initialization of merchant accounts with the bank by entering merchant data through a plurality of data entry screens within the express processing module, the merchant data being compiled and formatted for transmission to the bank which in turn opens the merchant account upon completion and approval of all data requirements.

21. The computer system of claim 20, wherein the express processing module includes:
a merchant management module for adding, editing, and maintaining the merchant data; and
a terminal management module for adding, editing, and maintaining merchant terminal data.

22. The computer system of claim 21, wherein the merchant management module and terminal management module each include:
a presentation tier for interfacing with users and external systems;
a business logic tier for defining rules by which the merchant management module and terminal management module operate; and
a data persistence tier for interfacing with a central database which stores the merchant data.

23. The computer system of claim 20, wherein the data entry screens of the express processing module are customized to perform data entry formatting and error checking according to requirements of the bank.

24. The computer system of claim 20, wherein the data entry screens of the express processing module are remotely accessible through a computer network.
